(19) United States
(12) Patent Application Publication
(10) Pub. No.: US 2022/0340757 A1
(43) Pub. Date: Oct. 27, 2022

(54) PROCESS FOR THE PREPARATION OF AN ASPHALT MIX COMPOSITION

(71) Applicant: BASF SE, Ludwigshafen am Rhein (DE)

(72) Inventors: Waldemar SCHATZ, Lemfoerde (DE); Iran OTERO MARTINEZ, Lemfoerde (DE); Michael ZEILINGER, Ludwigshafen am Rhein (DE); Bernie Lewis MALONSON, Wyandotte, MI (US); Dag WIEBELHAUS, Ludwigshafen am Rhein (DE); Karl R. GUST, Wyandotte, MI (US); Stefan BOKERN, Lemfoerde (DE); Olivier FLEISCHEL, Ludwigshafen am Rhein (DE)

(21) Appl. No.: 17/760,796

(22) PCT Filed: Sep. 17, 2020
(86) PCT No.: PCT/EP2020/076028

§ 371 Date: Mar. 16, 2022

(30) Foreign Application Priority Data
Sep. 18, 2019 (EP) 19198042.4

(51) Int. Cl. C08L 85/00; E01C 7/22; E01C 7/26

(52) U.S. Cl. CPC C08L 85/00; E01C 7/22; E01C 7/265; C08L 2203/30; C08L 2555/22; C08L 2555/24; C08L 2555/60

(57) ABSTRACT

The present invention relates to a process for the preparation of an asphalt mix composition, said process comprising: (1) providing an asphalt composition and heating said composition to a temperature in the range of from 110 to 200° C.; (2) providing a granular material and heating said material to a temperature in the range of from 110 to 240° C.; (3) providing one or more thermosetting reactive compounds; (4) adding the one or more thermosetting reactive compounds provided in (3) to the asphalt composition obtained in (1) and homogenizing the mixture for a duration in the range of from 2 to 180 s; (5) adding the mixture obtained in (4) to the granular material obtained in (2) and homogenizing the slurry for a duration in the range of from 5 to 180 s. Further, the present invention relates to an asphalt mix composition obtained or obtainable by said process and its use.

### TECHNICAL FIELD

The present invention relates to a process for the preparation of an asphalt mix composition, an asphalt mix composition obtained or obtainable by said process, and the use thereof.

### INTRODUCTION

In general, asphalt is a colloidal material containing different molecular species classified into asphaltenes and maltenes. Asphalt being viscoelastic and thermoplastic suffers property variation over a range of temperatures, from extreme cold to extreme heat. Asphalt tends to soften in hot weather and crack in extreme cold. At cold temperatures, asphalts become brittle and are subject to crack while at elevated temperatures they soften and lose physical properties.

The addition of a thermosetting reactive component as binders respectively in more general terms as modifier allows the physical properties of the asphalt to remain more constant over a range of temperatures and/or improve the physical properties over the temperature range the asphalt is subjected to.

Such asphalts that are modified by added binders respectively modifiers are known for years in the state of the art. But there is still a need in the asphalt industry, however, for improved asphalts. In part this is because currently known polymer-modified asphalts have a number of deficiencies. These include susceptibility to for instance permanent deformation (rutting), flexural fatigue, moisture, decrease of elasticity at low temperature operation.

WO 01/30911 A1 discloses an asphalt composition comprising, by weight based on the total weight of the composition, about 1 to 8%, of a polymeric MDI, where the polymeric MDI has a functionality of at least 2.5. It also relates to a process for preparing said asphalt composition, using reaction times of below 2 hours. The formation of the product MDI-asphalt is measured by an increase in the product's viscosity or more preferably by dynamic mechanical analysis (DMA).

WO 01/30912 A1 discloses an aqueous asphalt emulsion comprising, besides asphalt and water, an emulsifiable polyisocyanate. It also relates to an aggregate composition comprising said emulsion, and to processes for preparing said compositions

WO 01/30913 A1 discloses an asphalt composition comprising, by weight based on the total weight of the composition, about 1 to 5%, of a polymeric MDI based prepolymer, where the polymeric MDI has a functionality of at least 2.5. It also relates to a process for preparing said asphalt composition.

https://eapa.org/wp-content/uploads/2018/07/EAPA-paper-Warm-MixAsphalt-version-2014-1.pdf “The use of Warm Mix Asphalt”, EAPA Position Paper, 1 Jan. 2014, pp 1-23, discloses Warm Mix Asphalt (WMA) technologies for producing asphalt at temperatures slightly above 100° C. with properties or performance equivalent to that of conventional HMA.

https://www.faa.gov/documentlibrary/media/advisory_circular/150-5370-14A/150_5370_14a_app_1_part_II_a.pdf: “Hot Mix Asphalt Paving Handbook, AC 150/5370-14A, Appendix 1, Part II-a”, 1 Jan. 2001, pp 1-11, discloses hot-mix asphalt plant operations in the context of some types of asphalt plants, namely: batch plants, parallel-flow drum-mix plants, and counter-flow drum-mix plants.

http://web.archive.org/web/20071223141536/http://www.in.gov/indot/files/chapter_03(5).pdf: “HOT MIX ASPHALT PLANT OPERATIONS, Chapter 3”, 23 Dec. 2007, pp 1-78, discloses hot mix asphalt plant operations in the context of batch and drum plants, the effect of plant type on HMA properties, aggregate blending, plant inspection and scale check, plant calibration and plant trouble shooting.

http://www.astecinc.com/images/file/literature/Nomad_with_Baghouse.pdf: “NOMAD™ Hot Mix Asphalt Plant”, 1 Jan. 2008, pp 1-5, discloses the Nomad™ hot mix asphalt plant which comprises cold-feed bins, scalping screen, drying drum, liquid asphalt tank, twin-shaft coater, baghouse, surge bin and the control house.

https://store.asphaltpavement.org/pdfs/ec-101.pdf: “Best Management Practices To Minimize Emissions During HMA Construction; EC-101 4/00”, 1 Apr. 2000, pp 1-12, discloses best management practices to minimize emissions during HMA construction. In this context, it is disclosed that the Hot Mix Asphalt (HMA) producer must be aware that using appropriate storage, mixing, and compaction temperature for HMA is key to minimizing emissions. Furthermore, it is disclosed that a major goal should be to minimize temperatures while meeting specification densities.

Malcolm D Graham et al.: “Reduced Mixing Time for Asphalt Concrete Mixes”, Paper presented at the 47^{th} Annual Meeting, 1 Jan. 1968, pp 1-17, discloses reduced mixing time for asphalt concrete mixers—in which context it is mentioned that individual plant design and condition influence time requirements for adequate distribution and asphalt coating of aggregate particles, necessitating plant-by-plant testing to qualify for reduced times.

BECKER Y et al.: “Polymer Modified Asphalt”, VISION TECNOLOGICA, INTEVEP, LOS TEQUES, VE, vol. 9, no. 1, 1 Jan. 2001, pp 39-50, discloses modification of asphalt with polymers is considered the best option to improve asphalt properties. Furthermore, it is disclosed that polymers increase considerably the useful temperature range of the binders. Furthermore, it is disclosed that the possible limitations with modified bitumens are: (i) cost increase, (ii) possible compatibility and stability problems, (iii) some difficulties may arise in the storage of the bitumen, (iv) mixing temperatures, and (v) the length of time the material is held at elevated temperatures before laying.

Bjarne Bo Jensen et al.: “15 YEARS EXPERIENCE ADDING POLYMER POWDER DIRECTLY INTO THE ASPHALT MIXER”, 5^{th} Eurasphalt & Eurobitume Congress, 13-15 Jun. 2012, Istanbul, 15 Jun. 2012, pp 1-8, discloses that it has been tried to raise the polymer addition of a special polymer powder to get better asphalt characteristics (better rut resistance and better fatigue properties). Laboratory results show improved binder characteristics and field trials on different types of road shows improved functionality of the asphalt pavement (less crack propagation, better rut resistance). Furthermore, it is disclosed that when adding the polymer directly into the asphalt mixer it is possible to modify even small amounts of asphalt with different bitumen hardness, and there is no need for special bitumen storage facilities.

HESAMI EBRAHIM et al.: “Study of the amine-based liquid anti-stripping agents by simulating hot mix asphalt plant production process”, CONSTRUCTION AND BUILDING MATERIALS, vol. 157, 2017, pp 1011-1017, discloses simulating the HMA production conditions and then investigate the impacts of two types of liquid amine-based anti-stripping agents on the performance of HMA using the tensile strength ratio (TSR) and semi-circular Bending (SCB) tests. It is also disclosed that the results of this study indicated that effectiveness of these additives was significantly decreased after long-term being heated for HMA production.

LUO SANG et al.: “Performance evaluation of epoxy modified open graded porous asphalt concrete”, CONSTRUCTION AND BUILDING MATERIALS, ELSEVIER, NETHERLANDS, vol. 76, 12 Dec. 2014, pp 97-102, discloses a new open-graded porous asphalt mixture that uses epoxy asphalt as binder to improve mix durability. One type of epoxy asphalt that has been successfully applied in dense-graded asphalt concrete for bridge deck paving was selected for this study. Furthermore, is disclosed a procedure of compacting the mix into slab specimens and that a series of laboratory tests were conducted to evaluate the performance of the new mix, including Cantabro loss, permeability, acoustic absorption, indirect tensile, friction, shear stiffness and strength, and wheel rutting tests. Furthermore, is disclosed that the results showed superior overall performance of the epoxy modified open-graded porous asphalt mix compared to conventional open-graded porous asphalt mixes.

FANG CHANGQING et al.: “Preparation and properties of isocyanate and nano particles composite modified asphalt”, CONSTRUCTION AND BUILDING MATERIALS, ELSEVIER, NETHERLANDS, vol. 119, 13 May 2016, pp 113-118, discloses that isocyanate modified asphalt samples were got by adding quantitative isocyanate into the base asphalt. Isocyanate and nano particles composite modified asphalt samples were produced by adding quantitative isocyanate and three different kinds of inorganic nanoparticles (silicon dioxide, titanium dioxide, zinc oxide) into the base asphalt respectively. Isocyanate modified asphalt, isocyanate and nanoparticles composite modified asphalt were characterized by taking physical tests, SEM, fluorescence microscopy, TG and FTIR tests, which demonstrated that the high and low temperature performance of isocyanate and nano particles composite modified asphalt had been improved effectively. It is further disclosed that from the microscopic view, the modification of the base asphalt was very significant—and that results also indicated that the temperature sensitivity of composite modified asphalt had been decreased. Furthermore, is disclosed that meanwhile the thermal stability had been improved when compared with the base asphalt and isocyanate modified asphalt.

EP 3 006 525 A1 discloses an asphalt-urethane composition which contains at least a component (A) obtained by adding an MDI prepolymer generated by reacting polyolefin polyol having two or more hydroxyl groups, short-chain polyhydric alcohol, and a monomer of MDI, a monomer of MDI, and a solvent a; and a component (B) including asphalt, a catalyst, and a solvent b.

WO 2017/125421 A1 discloses a method for producing an asphalt composition for road pavement including a step of mixing asphalt, a polyester resin, and an aggregate at 130° C. or higher and 200° C. or lower for 30 seconds or more, wherein the polyester resin is a polyester having an alcohol component-derived constituent unit containing 65 mol % or more of an alkylene oxide adduct of bisphenol A and a carboxylic acid component-derived constituent unit containing 50 mol % or more of at least one selected from the group consisting of terephthalic acid and isophthalic acid and has a softening point of 95° C. or higher and 130° C. or lower and a hydroxyl group value of 20 mgKOH/g or more and 50 mgKOH/g or less, and the polyester resin is mixed in a ratio of 5 parts by mass or more and 50 parts by mass or less based on 100 parts by mass of the asphalt.

EP 0 537 638 B1 discloses polymer modified bitumen compositions which contain 0.5 to 10 parts by weight of functionalized polyoctenamer to 100 parts by weight of bitumen and, optionally, crosslinking agents characterized in that the polyoctenamer is predominantly a transpolyoctenamer and contains carboxyl groups, as well as groups derived therefrom for example maleic acid.

WO 2018/228840 A1, on the other hand, discloses an improved asphalt composition showing improved physical properties in terms of being more constant over a range of temperatures, said asphalt composition being obtained by a process involving the mixing of asphalt with a thermosetting reactive compound and stirring the mixture for at least 2.5 hours.

Although considerable improvements have been achieved for asphalt compositions with regard to their physical properties, said advantages require increased efforts in both time and energy.

In view thereof, there remains the need to provide improved methods for obtaining said materials in a highly effective manner, in particular with regard to time- and energy-efficiency.

### DETAILED DESCRIPTION

It was therefore an object of the present invention to provide an improved process for the preparation of an asphalt mix composition displaying advantageous physical properties.

According to the present invention, the terms “reclaimed asphalt pavement” (also abbreviated as RAP), “recycled asphalt”, “reclaimed asphalt”, “reclaimed asphalt pavement material”, and “reclaimed asphalt mix” are similarly used to describe a material that may also be described as “reprocessed pavement containing asphalt and aggregates”.

According to the present invention, the term “granular material” is similarly used to describe a component that may also be described as an “aggregate” or as “aggregates”. Further, in accordance with the present invention, a granular material or an aggregate may comprise one or more of gravel, sand, filler, and fine aggregates. Additional specific and/or preferred embodiments are disclosed herein in this regard.

Thus, it has surprisingly been found that as opposed to the teaching of the prior art, the duration of the mixing of a thermosetting reactive compound with asphalt prior to the addition of the resulting mixture with a granular material such as sand or gravel has substantially no influence on the degree of modification of the asphalt. Rather, it has quite unexpectedly been found that the conditions and the duration of mixing of the resulting mixture with the granular material may substantially improve the physical properties of the asphalt in terms of being more constant over a range of temperatures (i.e. the asphalt contained in such asphalt mix compositions shows an increased useful temperature interval (UTI), a reduced non-recoverable creep compliance (Jnr), an increased elastic response, an increased softening point, as well as a decreased needle penetration, and thus provides a better performance of the according asphalt mix composition in terms of e.g. rutting and fatigue resistance, low temperature resistance, and enhanced road durability across a broadened temperature range). This can be achieved even after a comparatively brief mixing stage. It has thus quite surprisingly been found that an asphalt mix composition having advantageous properties may be obtained using a specific sequence of comparatively short mixing steps, such as to not only afford considerable savings in time and energy, but furthermore allowing for the in-line blending of the starting components immediately before employing the product for pavement applications.

Therefore, the present invention relates to a process for the preparation of an asphalt mix composition, said process comprising:

(1) providing an asphalt composition and heating said composition to a temperature in the range of from 110 to 200° C.;

(2) providing a granular material and heating said material to a temperature in the range of from 110 to 240° C.;

(3) providing one or more thermosetting reactive compounds;

(4) adding the one or more thermosetting reactive compounds provided in (3) to the asphalt composition obtained in (1) and homogenizing the mixture for a duration in the range of from 2 to 180 s;

(5) adding the mixture obtained in (4) to the granular material obtained in (2) and homogenizing the slurry for a duration in the range of from 5 to 180 s.

It is preferred that the temperature of the homogenized slurry obtained in (5) is in the range of from 110 to 200° C., more preferably of from 130 to 197° C., more preferably of from 150 to 195° C., more preferably of from 170 to 192° C., more preferably of from 175 to 190° C., and more preferably of from 180 to 185° C.

It is preferred that the total duration starting with the addition of the thermosetting reactive compound in (4) until the subsequent obtainment of the homogenized slurry in (5) is in the range of from 10 s to 7 d, more preferably of from 10 s to 3 d, more preferably of from 15 s to 1 d, more preferably of from 15 s to 12 h, more preferably of from 20 s to 6 h, more preferably of from 20 s to 1 h, more preferably of from 25 s to 30 min, more preferably of from 25 s to 15 min, more preferably of from 30 s to 6 min, more preferably of from 30 s to 3 min, more preferably of from 35 s to 2 min, more preferably of from 35 s to 90 s, more preferably of from 40 s to 85 s, more preferably of from 45 s to 70 s, and more preferably of from 50 s to 60 s.

It is preferred that after (4) and prior to (5) the mixture obtained in (4) is stored at a temperature in the range of from 60 to 190° C., more preferably of from 70 to 185° C., more preferably of from 80 to 180° C., more preferably of from 90 to 175° C., more preferably of from 110 to 170° C., more preferably of from 130 to 165° C., and more preferably of from 150 to 160° C.

It is preferred that after (4) and prior to (5) the mixture obtained in (4) is stored for a duration in the range of from 0 s to 7 d, more preferably of from 5 s to 3 d, more preferably of from 10 s to 1 d, more preferably of from 15 s to 12 h, more preferably of from 20 s to 6 h, more preferably of from 25 s to 1 h, more preferably of from 30 s to 30 min, more preferably of from 35 s to 15 min, more preferably of from 40 s to 6 min, more preferably of from 45 s to 3 min, more preferably of from 50 s to 2 min, more preferably of from 55 s to 90 s, and more preferably of from 60 s to 70 s.

It is preferred that after (4) and prior to (5) the mixture obtained in (4) is subject to mixing at a mixing rate of 100 rpm or less, more preferably of 50 rpm or less, more preferably of 25 rpm or less, more preferably of 20 rpm or less, more preferably of 15 rpm or less, more preferably of 10 rpm or less, more preferably of 5 rpm or less, and more preferably of 3 rpm or less.

It is preferred that after (4) and prior to (5) the mixture obtained in (4) is not subject to mixing, wherein more preferably after (4) and prior to (5) the mixture obtained in (4) is not subject to homogenization.

Alternatively, it is preferred that the mixture obtained in (4) is directly processed in (5).

It is preferred that in (1) the asphalt composition is heated to a temperature in the range of from 130 to 197° C., more preferably of from 150 to 195° C., more preferably of from 170 to 192° C., more preferably of from 175 to 190° C., and more preferably of from 180 to 185° C.

It is preferred that in (2) the granular material is heated to a temperature in the range of from 130 to 220° C., more preferably of from 150 to 200° C., more preferably of from 170 to 195° C., more preferably of from 175 to 190° C., and more preferably of from 180 to 185° C.

It is preferred that homogenization in (5) is conducted at a temperature in the range of from 110 to 200° C., more preferably of from 130 to 195° C., more preferably of from 150 to 190° C., more preferably of from 170 to 185° C., and more preferably of from 175 to 180° C.

Generally, an asphalt composition used in the present invention can be any asphalt known and generally covers any bituminous compound. It can be any of the materials referred to as bitumen or asphalt. In particular, it is preferred within the context of the present invention that the term “asphalt” or “asphalt composition” as used herein refers to the definition contained in ASTM D8-02, wherein an asphalt is defined as a dark brown to black cementitious material in which the predominating constituents are bitumens which occur in nature or are obtained in petroleum processing.

It is preferred that the asphalt composition provided in (1) has a needle penetration selected from the list consisting of 20-30, 30-45, 35-50, 40-60, 50-70, 70-100, 100-150, 160-220, and 250-330 or performance grades of 52-16, 52-22, 52-28, 52-34, 52-40, 58-16, 58-22, 58-28, 58-34, 58-40, 64-16, 64-22, 64-28, 64-34, 64-40, 70-16, 70-22, 70-28, 70-34, 70-40, 76-16, 76-22, 76-28, 76-34, 76-40, more preferably the asphalt composition provided in (1) has a needle penetration selected from the list consisting of 30-45, 35-50, 40-60, 50-70, 70-100, 100-150, and 160-220 or performance grades of 52-16, 52-22, 52-28, 52-34, 52-40, 58-16, 58-22, 58-28, 58-34, 58-40, 64-16, 64-22, 64-28, 64-34, 70-16, 70-22, 70-28, 76-16, 76-22, more preferably the asphalt composition provided in (1) has a needle penetration selected from the list consisting of 40-60, 50-70, 70-100, and 100-150 or performance grades of 52-16, 52-22, 52-28, 52-34, 52-40, 58-16, 58-22, 58-28, 58-34, 64-16, 64-22, 64-28, 70-16, 70-22, 76-16, 76-22, wherein more preferably the asphalt composition provided in (1) has a needle penetration of 50-70 or 70-100, wherein the needle penetration is determined according to DIN EN 1426.

It is preferred that the asphalt composition provided in (1) comprises modified bitumen, preferably polymer modified bitumen. More preferably, the asphalt composition provided in (1) consists of modified bitumen, more preferably of polymer modified bitumen.

In the case where the asphalt composition provided in (1) comprises modified bitumen, it is preferred that the bitumen is modified with one or more compounds selected from the group consisting of thermoplastic elastomers, latex, thermoplastic polymers, thermosetting polymers, and mixtures of two or more thereof.

In the case where the bitumen is modified with thermoplastic elastomers, it is preferred that the thermoplastic elastomers are selected from the group consisting of styrene butadiene elastomer (SBE), styrene butadiene styrene (SBS), styrene butadiene rubber (SBR), styrene isoprene styrene (SIS), styrene ethylene butadiene styrene (SEBS), ethylene propylene diene terpolymer (EPDT), isobutene isoprene copolymer (IIR), polyisobutene (PIB), polybutadiene (PBD), polyisoprene (PI), and mixtures of two or more thereof.

In the case where the bitumen is modified with latex, it is preferred that the latex is natural rubber.

In the case where the bitumen is modified with thermoplastic polymers, it is preferred that the thermoplastic polymers are selected from the group consisting of ethylene vinyl acetate (EVA), ethylene methyl acrylate (EMA), ethylene butyl acrylate (EBA), atactic polypropylene (APP), polyethylene (PE), polypropylene (PP), polyvinyl chloride (PVC), polystyrene (PS), and mixtures of two or more thereof.

In the case where the bitumen is modified with thermosetting polymers, it is preferred that the thermosetting polymers are selected from the group consisting of epoxy resin, polyurethane resin, acrylic resin, phenolic resin, and mixtures of two or more thereof.

In the case where the asphalt composition provided in (1) comprises modified bitumen, it is preferred that the bitumen is modified using one or more compound selected from the group consisting of chemical modifiers (e.g. organometallic compounds, sulfur, phosphoric acid (PA), polyphosphoric acid (PPA), sulfonic acid, sulfuric acid, carboxylic anhydrides, acid esters, dibenzoyl peroxide, silanes, organic and inorganic sulfides urea), recycled materials (e.g. crumb rubber, plastics), fibers (e.g. lignin, cellulose, glass fibers, alumino magnesium silicate, polyester, polypropylene), adhesion improvers (e.g. organic amines, amides), natural asphalt (e.g. Trinidad lake asphalt (TLA), gilsonite, rock asphalt), anti-oxidants (e.g. phenols, organo-zinc compounds, organo-lead compounds), fillers (e.g. carbon black, hydrated lime, lime, fly ash), viscosity modifiers (e.g. flux oils, waxes), reactive polymers (e.g. random terpolymer of ethylene, acrylic ester and glycidyl methacrylate, maleic anhydride-grafted styrene-butadiene-styrene copolymer), and mixtures of two or more thereof.

It is preferred that the one or more thermosetting reactive compounds comprise one or more compounds selected from the group consisting of polyisocyanates, epoxy resins, melamine formaldehyde resins, and mixtures of two or more thereof, preferably from the group consisting of aliphatic polyisocyanates, araliphatic polyisocyanates, aromatic polyisocyanates, and mixtures of two or more thereof, more preferably from the group consisting of aromatic diisocyanates, oligomeric aromatic polyisocyanates, and mixtures of two or more thereof, wherein more preferably the one or more thermosetting reactive compounds comprise a mixture of one or more aromatic diisocyanates with one or more oligomeric aromatic polyisocyanates, wherein more preferably the one or more thermosetting reactive compounds consist of a mixture of one or more aromatic diisocyanates with one or more oligomeric aromatic polyisocyanates.

According to the present invention, it is preferred that the polyisocyanates are the aliphatic, cycloaliphatic, araliphatic and more preferably the aromatic polyvalent isocyanates known in the art. Such polyfunctional isocyanates are known and can be produced by methods known per se.

The polyfunctional isocyanates can also be used in particular as mixtures, so that the polyisocyanates in this case contains various polyfunctional isocyanates. According to the present invention, a polyisocyanate is a polyfunctional isocyanate having two (hereafter called diisocyanates) or more than two isocyanate groups per molecule. Furthermore, according to the present invention, the term “oligomeric polyisocyanates” and more specifically “oligomeric aromatic polyisocyanates” designate polyfunctional isocyanates having three or more than three isocyanate groups per molecule.

In particular, it is preferred according to the present invention that the polyisocyanates are selected from the group consisiting of alkylenediisocyanates with 4 to 12 carbon atoms in the alkylene radical, such as 1,12-dodecanediioscyanate, 2-ethyltetramethylenediisocyanate-1,4,2-methylpentamethylenediisocyanate-1,5, tetramethylenediisocyanate-1,4, and preferably hexamethylenediisocyanate-1,6; cycloaliphatic diisocyanates such as cyclohexane-1,3- and 1,4-diisocyanate and any mixtures of these isomers, 1-isocyanato-3,3,5-trimethyl-5-isocyanatomethylcyclohexane (IPDI), 2,4- and 2,6-hexahydrotoluene diisocyanate and the corresponding isomer mixtures, 4,4′-, 2,2′- and 2,4′-dicyclohexylmethane diisocyanate and the corresponding isomer mixtures, and preferably aromatic polyisocyanates, such as 2,4- and 2,6-toluene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, polyphenylpolymethylene polyisocyanates, mixtures of 4,4′-, 2,4′- and 2,2′-diphenylmethane diisocyanates and polyphenylpolyethylene polyisocyanates and mixtures of MDI and toluene diisocyanates.

Particularly suitable are 2,2′-, 2,4′- and/or 4,4′-diphenylmethane diisocyanate, 1,5-naphthylene diisocyanate (NDI), 2,4- and/or 2,6-toluene diisocyanate (TDI), 3,3′-dimethyl diphenyl diisocyanate, 1,2-diphenylethane diisocyanate and/or p-phenylene diisocyanate (PPDI), tri-, tetra-, penta-, hexa-, hepta- and/or octamethyl diisocyanate, 2-methylpentamethylene-1,5-diisocyanate, 2-ethylbutylene-1,4-diisocyanate, pentamethylene-1,5-diisocyanate, butylene-1,4-diisocyanate, 1-isocyanato-3,3,5-trimethyl-5-iso-cyanatomethyl-cyclohexane (isophorone diisocyanate, IPDI), 1,4- and/or 1,3-Bis(isocyanatomethyl)cyclohexane (HXDI), 1,4-cyclohexane diisocyanate, 1-methyl-2,4- and/or -2,6-cyclohexane diisocyanate and 4,4′-, 2,4′- and/or 2,2′-dicyclohexylmethane diisocyanate.

Modified polyisocyanates, i.e. products obtained by the chemical reaction of organic polyisocyanates and containing at least two reactive isocyanate groups per molecule, are also preferably used. Particularly mentioned are polyisocyanates containing ester, urea, biuret, allophanate, carbodiimide, isocyanurate, uretdione, carbamate and/or urethane groups, often also together with unreacted polyisocyanates.

According to the present invention, the polyisocyanates particularly preferably contain 2,2′-MDI or 2,4′-MDI or 4,4′-MDI or mixtures of at least two of these isocyanates (also referred to as monomeric diphenylmethane or MMDI) or oligomeric MDI consisting of higher-core homologues of the MDI which have at least 3 aromatic nuclei and a functionality of at least 3, or mixtures of two or more of the above-mentioned diphenylmethane diisocyanates, or crude MDI obtained in the preparation of MDI, or preferably mixtures of at least one higher-core homologues of the MDI and at least one of the low molecular weight MDI derivatives 2,2′-MDI, 2,4′-MDI or 4,4′-MDI (mixture is also referred to as polymeric MDI). The average functionality of a polyisocyanate containing polymeric MDI may vary in the range from about 2.2 to about 4, in particular from 2.4 to 3.8 and in particular from 2.6 to 3.0.

Polyfunctional isocyanates or mixtures of several polyfunctional isocyanates based on MDI are known and are commercially available, for example from BASF SE. According to the present invention, the one or more thermosetting reactive compounds preferably contain at least 70, particularly preferably at least 90 and in particular 100 wt.%, based on the total weight of the one or more thermosetting reactive compounds, of one or more isocyanates selected from the group consisting of 2,2′-MDI, 2,4′-MDI, 4,4′-MDI and higher homologues of the MDI. The content of higher homologues with more than 3 rings is preferably at least 20% by weight, particularly preferably greater than 30% to less than 80% by weight, based on the total weight of the one or more thermosetting reactive compounds.

The viscosity of the one or more thermosetting reactive compounds used in the inventive process can vary over a wide range. It is preferred that the one or more thermosetting reactive compounds have a viscosity of 100 to 3000 mPa*s, especially preferred from 100 to 1000 mPa*s, especially preferred from 100 to 600 mPa*s, more especially from 200 to 600 mPa*s and especially from 400 to 600 mPa*s at 25° C. The viscosity of the one or more thermosetting reactive compounds may vary within a wide range

In the case where the one or more thermosetting reactive compounds comprise aliphatic polyisocyanates, it is preferred that the aliphatic polyisocyanates comprise one or more compounds selected from the group consisting of alkylenediisocyanates with 4 to 12 carbon atoms in the alkylene radical and mixtures of two or more thereof, 1,12-dodecanediioscyanate, 2-ethyltetramethylenediisocyanate-1,4, 2-methylpentamethylenediisocyanate-1,5, tetramethylenediisocyanate-1,4, hexamethylenediisocyanate-1,6, trimethyl diisocyanate, tetramethyl diisocyanate, pentamethyl diisocyanate, hexamethyl diisocyanate, heptamethyl diisocyanate, octamethyl diisocyanate, 2-methylpentamethylene-1,5-diisocyanate, 2-ethylbutylene-1,4-diisocyanate, pentamethylene-1,5-diisocyanate, butylene-1,4-diisocyanate, preferably from the group consisting of trimethyl diisocyanate, tetramethyl diisocyanate, pentamethyl diisocyanate, hexamethyl diisocyanate, heptamethyl diisocyanate, octamethyl diisocyanate, 2-methylpentamethylene-1,5-diisocyanate, 2-ethylbutylene-1,4-diisocyanate, pentamethylene-1,5-diisocyanate, butylene-1,4-diisocyanate, and mixtures of two or more thereof, wherein more preferably the aliphatic polyisocyanates comprise hexamethylenediisocyanate-1,6, wherein more preferably the aliphatic polyisocyanates consist of hexamethylenediisocyanate-1,6.

In the case where the one or more thermosetting reactive compounds comprise cycloaliphatic polyisocyanates, it is preferred that the aliphatic polyisocyanates comprise one or more cycloaliphatic compounds selected from the group consisting of 1-isocyanato-3,3,5-trimethyl-5-isocyanatomethyl-cyclohexane (isophorone diisocyanate, IPDI), 1,4-Bis(isocyanatomethyl)cyclohexane and/or 1,3-Bis(isocyanatomethyl)cyclohexane (HXDI), 1,4-cyclohexane diisocyanate, 1-methyl-2,4- and/or -2,6-cyclohexane diisocyanate and 4,4′-dicyclohexylmethane diisocyanate, 2,2′-dicyclohexylmethane diisocyanate, 2,4′-dicyclohexylmethane diisocyanate, cyclohexane-1,3- diisocyanate, cyclohexane-1,4-diisocyanate, 2,4- hexahydrotoluene diisocyanate, 2,6-hexahydrotoluene diisocyanate, 4,4′-dicyclohexylmethane diisocyanate, 2,2′-dicyclohexylmethane diisocyanate, 2,4′-dicyclohexylmethane diisocyanate, and mixtures of two or more thereof, preferably from the group consisting of 1-isocyanato-3,3,5-trimethyl-5-iso-cyanatomethyl-cyclohexane (isophorone diisocyanate, IPDI), 1,4-Bis(isocyanatomethyl)cyclohexane and/or 1,3-Bis(isocyanatomethyl)cyclohexane (HXDI), 1,4-cyclohexane diisocyanate, 1-methyl-2,4- and/or -2,6-cyclohexane diisocyanate and 4,4′-dicyclohexylmethane diisocyanate, 2,2′-dicyclohexylmethane diisocyanate, 2,4′-dicyclohexylmethane diisocyanate, and mixtures of two or more thereof.

In the case where the one or more thermosetting reactive compounds comprise aromatic polyisocyanates, it is preferred that the aromatic polyisocyanates, and preferably the aromatic diisocyanates, comprise one or more compounds selected from the group consisting of 2,4-toluene diisocyanate, 2,6-toluene diisocyanate, 4,4′-diphenylmethane diisocyanate, 2,4′-diphenylmethane diisocyanate, 2,2′-diphenylmethane diisocyanate, 1,5-naphthylene diisocyanate (NDI), 3,3′-dimethyl diphenyl diisocyanate, 1,2-diphenylethane diisocyanate, p-phenylene diisocyanate (PPDI), and mixtures of two or more thereof, preferably from the group consisting of 2,4-toluene diisocyanate (2,4-TDI), 2,6-toluene diisocyanate (2,6-TDI), 4,4′-diphenylmethane diisocyanate (4,4′-MDI), 2,4′-diphenylmethane diisocyanate (2,4′-MDI), 2,2′-diphenylmethane diisocyanate (2,2′-MDI), crude MDI obtained in the preparation of MDI, and mixtures of two or more thereof, more preferably from the group consisting of 4,4′-diphenylmethane diisocyanate, 2,4′-diphenylmethane diisocyanate, 2,2′-diphenylmethane diisocyanate, and mixtures of two or more thereof (mixtures of the isomers 4,4′-, 2,4′- and 2,2′-diphenylmethane diisocyanate are also referred to as monomeric diphenylmethane or MMDI), wherein more preferably the aromatic polyisocyanates, and preferably the aromatic diisocyanates, comprise a mixture of 4,4′-diphenylmethane diisocyanate, 2,4′-diphenylmethane diisocyanate, and 2,2′-diphenylmethane diisocyanate, wherein more preferably the aromatic polyisocyanates, and preferably the aromatic diisocyanates, consist of a mixture of 4,4′-diphenylmethane diisocyanate, 2,4′-diphenylmethane diisocyanate, and 2,2′-diphenylmethane diisocyanate.

In the case where the one or more thermosetting reactive compounds comprise polyisocyanates, it is preferred that the polyisocyanates comprise modified polyisocyanates, preferably modified organic polyisocyanates, and more preferably modified organic polyisocyanates containing one or more ester, urea, biuret, allophanate, carbodiimide, isocyanurate, uretdione, carbamate and/or urethane groups.

In the case where the one or more thermosetting reactive compounds comprise oligomeric aromatic polyisocyanates, it is preferred that the oligomeric aromatic polyisocyanates comprise one or more compounds selected from the group consisting of polyphenylpolymethylene polyisocyanates, polyphenylpolyethylene polyisocyanates, and mixtures of two or more thereof, preferably from the group consisting of one or more polymethylene polyphenylisocyanates, polyethylene polyphenylisocyanates, and mixtures of two or more thereof, wherein more preferably the aromatic polyisocyanates comprise one or more polymethylene polyphenylisocyanates, wherein more preferably the aromatic polyisocyanates consist of one or more polymethylene polyphenyl isocyanates.

In the case where the one or more thermosetting reactive compounds comprise oligomeric aromatic polyisocyanates, it is preferred that the oligomeric aromatic polyisocyanates comprise one or more oligomers consisting of higher-core homologues of one or more of 4,4′-diphenylmethane diisocyanate, 2,4′-diphenylmethane diisocyanate, and 2,2′-diphenylmethane diisocyanate, wherein the higher-core homologues have at least 3 aromatic nuclei and a functionality of at least 3.

In the case where the one or more thermosetting reactive compounds comprise one or more compounds selected from the group consisting of polyisocyanates, epoxy resins, melamine formaldehyde resins, and mixtures of two or more thereof, it is preferred that the one or more thermosetting reactive compounds is polymeric MDI and the total amount of 4,4′-MDI in the polymeric MDI is in the range of from 26 to 98 wt.-% based on 100 wt.-% of the one or more thermosetting reactive compounds, preferably in the range of from 30 to 95 wt.-%, and more preferably in the range of from 35 to 92 wt.-%.

In the case where the one or more thermosetting reactive compounds comprise one or more compounds selected from the group consisting of polyisocyanates, epoxy resins, melamine formaldehyde resins, and mixtures of two or more thereof, it is preferred that the one or more thermosetting reactive compounds is polymeric MDI and the 2 rings content of polymeric MDI is in the range of from 20 to 62%, more preferably in the range of from 26 to 48 wt.-%, and most preferably in the range of from 26 to 48% based on 100 wt.-% of the polymeric MDI. In the case where the one or more thermosetting reactive compounds comprise one or more compounds selected from the group consisting of polyisocyanates, epoxy resins, melamine formaldehyde resins, and mixtures of two or more thereof, it is preferred that the one or more thermosetting reactive compounds, and preferably the total of the polyisocyanates contained therein, have an average isocyanate functionality of from 2.1 to 3.5, preferably of from 2.3 to 3.2, more preferably of from 2.4 to 3, more preferably of from 2.5 to 2.9, and more preferably of from 2.6 to 2.8.

It is preferred that the one or more thermosetting reactive compounds have an iron content in the range of from 1 to 100 wppm, preferably of from 1 to 80 wppm, more preferably of from 1 to 60 wppm, more preferably of from 1 to 40 wppm, more preferably of from 1 to 20 wppm, more preferably of from 1 to 10 wppm, and more preferably of from 1 to 5 wppm.

It is preferred that the one or more thermosetting reactive compounds display a viscosity in the range of from 100 to 3000 mPa*s, preferably of from 100 to 1000 mPa*s, more preferably of from 100 to 600 mPa*s, more preferably of from 200 to 600 mPa*s, and more preferably of from 400 to 600 mPa*s, wherein the viscosity is the viscosity measured at 25° C.

In the case where the one or more thermosetting reactive compounds comprise one or more epoxy resins, it is preferred that the epoxy resins comprise one or more compounds selected from the group of aromatic epoxy resins, cycloaliphatic epoxy resins, and mixtures of two or more thereof, more preferably one or more compounds selected from the group consisting of bisphenol A bisglycidyl ether (DGEBA), bisphenol F bisglycidyl ether, ring-hydrogenated bisphenol A bisglycidyl ether, ring-hydrogenated bisphenol F bisglycidyl ether, bisphenol S bisglycidyl ether (DGEBS), tetraglycidylmethylenedianiline (TGMDA), epoxy novolaks (the reaction products from epichlorohydrin and phenolic resins (novolak)), 3,4-epoxycyclohexylmethyl, 3,4-epoxycyclohexanecarboxylate, diglycidyl hexahydrophthalate, and mixtures of two or more thereof, wherein more preferably the epoxy resins comprise bisphenol A bisglycidyl ether and/or bisphenol F bisglycidyl ether, wherein more preferably the epoxy resins consist of bisphenol A bisglycidyl ether and/or bisphenol F bisglycidyl ether.

In the case where the one or more thermosetting reactive compounds comprise one or more melamine formaldehyde resins, it is preferred that the melamine formaldehyde resins comprise an aqueous melamine resin mixture with a resin content in the range of 50 to 70 weight-% based on 100 weight-% of the aqueous melamine resin mixture, with melamine and formaldehyde present in the resin in a molar ratio of from 1:3 to 1:1, preferably of from 1:1.3 to 1:2.0, and more preferably of from 1:1.5 to 1:1.7.

Further in the case where the one or more thermosetting reactive compounds comprise one or more melamine formaldehyde resins, it is preferred that the melamine formaldehyde resins contain 1 to 10 weight-% of polyvalent alcohols, more preferably 3 to 6 weight-% of polyvalent alcohols, more preferably 3 to 6 weight-% of C2 to C12 diols, more preferably 3 to 6 weight-% of one or more compounds selected from the group consisting of diethylene glycol, propylene glycol, butylene glycol, pentane diol, hexane diol, and mixtures of two or more thereof, and more preferably 3 to 6 weight-% of diethylene glycol.

Further in the case where the one or more thermosetting reactive compounds comprise one or more melamine formaldehyde resins, it is preferred that the melamine formaldehyde resins contain 0 to 8 weight-% of caprolactam and 0.5 to 10 weight-% of 2-(2-phenoxyethoxy)-ethanol and/or polyethylene glycol with an average molecular mass of 200 to 1500 each based on 100 weight-% of the melamine formaldehyde resins.

It is preferred that in (4) the mixture is homogenized for a duration in the range of from 3 to 120 s, more preferably of from 4 to 90 s, more preferably of from 6 to 60 s, more preferably of from 8 to 40 s, more preferably of from 10 to 30 s, more preferably of from 12 to 25 s, and more preferably of from 15 to 20 s.

It is preferred that in (5) the slurry is homogenized for a duration in the range of from 10 to 120 s, more preferably of from 15 to 100 s, more preferably of from 20 to 80 s, more preferably of from 30 to 60 s, and more preferably of from 40 to 50 s.

It is preferred that the weight ratio of the total amount of the one or more thermosetting reactive compounds to the asphalt composition is in the range of from 0.1:99.9 to 25:75, more preferably of from 0.3:99.7 to 15:85, more preferably of from 0.5:99.5 to 10:90, more preferably of from 0.8:99.2 to 7:93, more preferably of from 1:99 to 5:95, more preferably of from 1.3:98.7 to 4:96, more preferably of from 1.5:98.5 to 3.5:96.5, more preferably of from 1.8:98.2 to 3.2:96.8, more preferably of from 2:98 to 3:97, more preferably of from 2.2:97.8 to 2.8:97.2, and more preferably of from 2.4:97.6 to 2.6:97.4.

It is preferred that the weight ratio of the mixture obtained in (4) to the granular material obtained in (2) is in the range of from 0.5:99.5 to 25:75, more preferably of from 1:99 to 20:80, more preferably of from 1.5:98.5 to 15:85, more preferably of from 2:98 to 10:90, more preferably of from 2.5:97.5 to 7:93, more preferably of from 3:97 to 5:95, and more preferably of from 3.5:96.5 to 4.5:95.5.

It is preferred that the granular material provided in (2) comprises one or more granular materials selected from the group consisting of gravel, reclaimed asphalt pavement, sand, one or more filler materials, and mixtures of two or more thereof, more preferably from the group consisting of limestone, basanite, diabase, reclaimed asphalt pavement, and mixtures of two or more thereof, and more preferably from the group consisting of limestone, basanite, diabase, reclaimed asphalt pavement, and mixtures of two or more thereof.

It is preferred that the asphalt composition provided in (1) comprises one or more additives, more preferably one or more fiber materials and/or one or more rejuvenators. It is particularly preferred that the asphalt composition provided in (1) comprises cellulose fibers. According to the present invention, fiber materials, rejuvenators, and cellulose fibers are considered as additives.

In the case where the asphalt composition provided in (1) comprises one or more additives, it is preferred that the asphalt composition provided in (1) comprises 10 weight-% or less of the one or more additives, based on 100 weight-% of the asphalt composition, preferably 5 weight-% or less, more preferably 3 weight-% or less, more preferably 2 weight-% or less, more preferably 1 weight-% or less, more preferably 0.5 weight-% or less, and more preferably 0.1 weight-% or less of the one or more additives, based on 100 weight-% of the asphalt composition.

It is preferred that the granular material provided in (2) comprises from 5 to 100 weight-% of reclaimed asphalt pavement, based on 100 weight-% of the granular material, wherein more preferably the granular material comprises from 10 to 90 weight-%, more preferably from 15 to 80 weight-%, more preferably from 20 to 70 weight-%, more preferably from 25 to 60 weight-%, more preferably from 30 to 50 weight-%, and more preferably from 35 to 45 weight-% of reclaimed asphalt pavement, based on 100 weight-% of the granular material.

No particular restriction applies to the grain size of the granular material provided in (2). It is preferred that the granular material provided in (2) displays a grain size in the range of from 0.1 to 70 mm, more preferably of from 0.3 to 50 mm, more preferably of from 0.5 to 40 mm, more preferably of from 1 to 30 mm, more preferably of from 3 to 25 mm, more preferably of from 5 to 20 mm, more preferably of from 7 to 15 mm, and more preferably of from 8 to 11 mm.

It is preferred that addition in (4) is achieved by injection of at least a portion of the one or more thermosetting reactive compounds into at least a portion of the asphalt composition. It is particularly preferred that the injection is achieved with the aid of a dosage pump.

It is preferred that addition in (4) is conducted in a receiver tank, more preferably in a weighted receiver tank.

In the case where addition in (4) is conducted in a receiver tank or in a weighted receiver tank, it is preferred that the asphalt composition obtained in (1) is added to the receiver tank or to the weighted receiver tank prior to the addition of the one or more thermosetting reactive compounds.

It is preferred that homogenization in (4) is achieved with the aid of one or more dynamic mixing elements, more preferably with the aid of one or more circulation pumps and/or high shear mixers and/or one or more stirrers and/or one or more screws, more preferably with the aid of one or more stirrers.

It is preferred that homogenization in (4) is achieved with the aid of one or more static mixing elements, more preferably with the aid of one or more nozzles and/or Sulzer mixers and/or Kenics mixers.

It is preferred that homogenization in (4) is conducted at least in part in a mixing unit, more preferably in a weighted stirred vessel.

It is preferred that homogenization in (4) is achieved by mixing. In the case where homogenization in (4) is achieved by mixing, it is preferred that the mixing rate is in the range of from 30 to 12,000 rpm, more preferably of from 50 to 8,000 rpm, more preferably of from 100 to 5,000 rpm, more preferably of from 300 to 4,000 rpm, more preferably of from 500 to 3,000 rpm, more preferably of from 800 to 2,500 rpm, more preferably of from 1,000 to 2,000 rpm, more preferably of from 1,200 to 1,800 rpm, and more preferably of from 1,400 to 1,600 rpm.

It is preferred that addition in (5) is achieved by injection of at least a portion of the mixture obtained in (4) into at least a portion of granular material obtained in (2). It is particularly preferred that addition in (5) is achieved by injection of at least a portion of the mixture obtained in (4) into at least a portion of granular material obtained in (2) with the aid of a dosage pump.

It is preferred that homogenization in (5) is achieved by with the aid of one or more dynamic mixing elements, more preferably with the aid of one or more stirrers and/or one or more screws, more preferably with the aid of a double shaft compulsory mixer (twin-shaft pugmill).

It is preferred that homogenization in (5) is conducted in a mixing device. It is particularly preferred that the mixing device is part of an asphalt mixing plant.

In the case where homogenization in (5) is conducted in a mixing device, it is preferred that the granular material obtained in (2) is added to the mixing device prior to the addition of the mixture obtained in (4).

It is preferred that in (4), addition and homogenization are conducted simultaneously.

It is preferred that in (5), addition and homogenization are conducted simultaneously.

It is preferred that (4) and/or (5), more preferably (4) and (5), are conducted under an oxygen containing atmosphere, more preferably under an atmosphere containing oxygen in an amount from 1 to 21 volume-%, more preferably from 5 to 21 volume-%, and more preferably from 10 to 21 volume-%. It is particularly preferred that (4) and/or (5), more preferably (4) and (5), are conducted under air.

It is preferred that (4) and/or (5), more preferably (4) and (5), are conducted as a batch process or as a continuous process. It is particularly preferred that (4) and/or (5), more preferably (4) and (5), are conducted as a continuous process.

Further, the present invention relates to an asphalt mix composition obtained or obtainable according to the process of any one of the embodiments disclosed herein.

Yet further, the present invention relates to a use of an asphalt mix composition according to any one of the embodiments disclosed herein for pavement applications.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A process for the preparation of an asphalt mix composition, said process comprising:
   (1) providing an asphalt composition and heating said composition to a temperature in the range of from 110 to 200° C.;
   (2) providing a granular material and heating said material to a temperature in the range of from 110 to 240° C.;
   (3) providing one or more thermosetting reactive compounds;
   (4) adding the one or more thermosetting reactive compounds provided in (3) to the asphalt composition obtained in (1) and homogenizing the mixture for a duration in the range of from 2 to 180 s;
   (5) adding the mixture obtained in (4) to the granular material obtained in (2) and homogenizing the slurry for a duration in the range of from 5 to 180 s;
   wherein the temperature of the homogenized slurry obtained in (5) is preferably in the range of from 110 to 200° C., more preferably of from 130 to 197° C., more preferably of from 150 to 195° C., more preferably of from 170 to 192° C., more preferably of from 175 to 190° C., and more preferably of from 180 to 185° C.
2. The process of embodiment 1, wherein the total duration starting with the addition of the thermosetting reactive compound in (4) until the subsequent obtainment of the homogenized slurry in (5) is in the range of from 10 s to 7 d, preferably of from 10 s to 3 d, more preferably of from 15 s to 1 d, more preferably of from 15 s to 12 h, more preferably of from 20 s to 6 h, more preferably of from 20 s to 1 h, more preferably of from 25 s to 30 min, more preferably of from 25 s to 15 min, more preferably of from 30 s to 6 min, more preferably of from 30 s to 3 min, more preferably of from 35 s to 2 min, more preferably of from 35 s to 90 s, more preferably of from 40 s to 85 s, more preferably of from 45 s to 70 s, and more preferably of from 50 s to 60 s.
3. The process of embodiment 1 or 2, wherein after (4) and prior to (5) the mixture obtained in (4) is stored at a temperature in the range of from 60 to 190° C., preferably of from 70 to 185° C., more preferably of from 80 to 180° C., more preferably of from 90 to 175° C., more preferably of from 110 to 170° C., more preferably of from 130 to 165° C., and more preferably of from 150 to 160° C.
4. The process of any one of embodiments 1 to 3, wherein after (4) and prior to (5) the mixture obtained in (4) is stored for a duration in the range of from 0 s to 7 d, preferably of from 5 s to 3 d, more preferably of from 10 s to 1 d, more preferably of from 15 s to 12 h, more preferably of from 20 s to 6 h, more preferably of from 25 s to 1 h, more preferably of from 30 s to 30 min, more preferably of from 35 s to 15 min, more preferably of from 40 s to 6 min, more preferably of from 45 s to 3 min, more preferably of from 50 s to 2 min, more preferably of from 55 s to 90 s, and more preferably of from 60 s to 70 s.
5. The process of any one of embodiments 1 to 4, wherein after (4) and prior to (5) the mixture obtained in (4) is subject to mixing at a mixing rate of 100 rpm or less, preferably of 50 rpm or less, more preferably of 25 rpm or less, more preferably of 20 rpm or less, more preferably of 15 rpm or less, more preferably of 10 rpm or less, more preferably of 5 rpm or less, and more preferably of 3 rpm or less.
6. The process of any one of embodiments 1 to 4, wherein after (4) and prior to (5) the mixture obtained in (4) is not subject to mixing, wherein preferably after (4) and prior to (5) the mixture obtained in (4) is not subject to homogenization.
7. The process of embodiment 1, wherein the mixture obtained in (4) is directly processed in (5).
8. The process of any one of embodiments 1 to 7, wherein in (1) the asphalt composition is heated to a temperature in the range of from 130 to 197° C., preferably of from 150 to 195° C., more preferably of from 170 to 192° C., more preferably of from 175 to 190° C., and more preferably of from 180 to 185° C.
9. The process of any one of embodiments 1 to 8, wherein in (2) the granular material is heated to a temperature in the range of from 130 to 220° C., preferably of from 150 to 200° C., more preferably of from 170 to 195° C., more preferably of from 175 to 190° C., and more preferably of from 180 to 185° C.
10. The process of any one of embodiments 1 to 9, wherein homogenization in (5) is conducted at a temperature in the range of from 110 to 200° C., preferably of from 130 to 195° C., more preferably of from 150 to 190° C., more preferably of from 170 to 185° C., and more preferably of from 175 to 180° C.
11. The process of any one of embodiments 1 to 10, wherein the asphalt composition provided in (1) has a needle penetration selected from the list consisting of 20-30, 30-45, 35-50, 40-60, 50-70, 70-100, 100-150, 160-220, and 250-330, more preferably from the list consisting of 30-45, 35-50, 40-60, 50-70, 70-100, 100-150, and 160-220, more preferably from the list consisting of 40-60, 50-70, 70-100, and 100-150, wherein more preferably the asphalt composition provided in (1) has a needle penetration of 50-70 or 70-100, wherein the needle penetration is determined according to DIN EN 1426.
12. The process of any one of embodiments 1 to 11, wherein the asphalt composition provided in (1) comprises modified bitumen, preferably polymer modified bitumen, wherein more preferably the asphalt composition provided in (1) consists of modified bitumen, more preferably of polymer modified bitumen.
13. The process of embodiment 12, wherein the bitumen is modified with one or more compounds selected from the group consisting of thermoplastic elastomers, latex, thermoplastic polymers, thermosetting polymers, and mixtures of two or more thereof.
14. The process of embodiment 13, wherein the thermoplastic elastomers are selected from the group consisting of styrene butadiene elastomer (SBE), styrene butadiene styrene (SBS), styrene butadiene rubber (SBR), styrene isoprenesStyrene (SIS), styrene ethylene butadiene styrene (SEBS), ethylene propylene diene terpolymer (EPDT), isobutene isoprene copolymer (IIR), polyisobutene (PI), polybutadiene (PBD), polyisoprene (PI), and mixtures of two or more thereof.
15. The process of embodiment 13 or 14, wherein the latex is natural rubber.
16. The process of any one of embodiments 13 to 15, wherein the thermoplastic polymers are selected from the group consisting of ethylene vinyl acetate (EVA), ethylene methyl acrylate (EMA), ethylene butyl acrylate (EBA), atactic polypropylene (APP), polyethylene (PE), polypropylene (PP), polyvinyl chloride (PVC), polystyrene (PS), and mixtures of two or more thereof.
17. The process of any one of embodiments 13 to 16, wherein the thermosetting polymers are selected from the group consisting of epoxy resin, polyurethane resin, acrylic resin, phenolic resin, and mixtures of two or more thereof.
18. The process of any one of embodiments 12 to 17, wherein the modified bitumen has been modified using one or more compound selected from the group consisting of chemical modifiers (e.g. organometallic compounds, sulfur, phosphoric acid (PA), polyphosphoric acid (PPA), sulfonic acid, sulfuric acid, carboxylic anhydrides, acid esters, dibenzoyl peroxide, silanes, organic and inorganic sulfides urea), recycled materials (e.g. crumb rubber, plastics), fibers (e.g. lignin, cellulose, glass fibers, alumino magnesium silicate, polyester, polypropylene), adhesion improvers (e.g. organic amines, amides), natural asphalt (e.g. Trinidad lake asphalt (TLA), gilsonite, rock asphalt), anti-oxidants (e.g. phenols, organozinc compounds, organo-lead compounds), fillers (e.g. carbon black, hydrated lime, lime, fly ash), viscosity modifiers (e.g. flux oils, waxes), reactive polymers (e.g. random terpolymer of ethylene, acrylic ester and glycidyl methacrylate, maleic anhydride-grafted styrene-butadiene-styrene copolymer), and mixtures of two or more thereof.
19. The process of any one of embodiments 1 to 18, wherein the one or more thermosetting reactive compounds comprise one or more compounds selected from the group consisting of polyisocyanates, epoxy resins, melamine formaldehyde resins, and mixtures of two or more thereof, preferably from the group consisting of aliphatic polyisocyanates, araliphatic polyisocyanates, aromatic polyisocyanates, and mixtures of two or more thereof, more preferably from the group consisting of aromatic diisocyanates, oligomeric aromatic polyisocyanates, and mixtures of two or more thereof, wherein more preferably the one or more thermosetting reactive compounds comprise a mixture of one or more aromatic diisocyanates with one or more oligomeric aromatic polyisocyanates, wherein more preferably the one or more thermosetting reactive compounds consist of a mixture of one or more aromatic diisocyanates with one or more oligomeric aromatic polyisocyanates.
20. The process of embodiment 19, wherein the aliphatic polyisocyanates comprise one or more compounds selected from the group consisting of alkylenediisocyanates with 4 to 12 carbon atoms in the alkylene radical and mixtures of two or more thereof, 1,12-dodecanediioscyanate, 2-ethyltetramethylenediisocyanate-1,4, 2-methylpentamethylenediisocyanate-1,5, tetramethylenediisocyanate-1,4, hexamethylenediisocyanate-1,6, trimethyl diisocyanate, tetramethyl diisocyanate, pentamethyl diisocyanate, hexamethyl diisocyanate, heptamethyl diisocyanate, octamethyl diisocyanate, 2-methylpentamethylene-1,5-diisocyanate, 2-ethylbutylene-1,4-diisocyanate, pentameth-ylene-1,5-diisocyanate, butylene-1,4-diisocyanate, preferably from the group consisting of trimethyl diisocyanate, tetramethyl diisocyanate, pentamethyl diisocyanate, hexamethyl diisocyanate, heptamethyl diisocyanate, octamethyl diisocyanate, 2-methylpentamethylene-1,5-diisocyanate, 2-ethylbutylene-1,4-diisocyanate, pentamethylene-1,5-diisocyanate, butylene-1,4-diisocyanate, and mixtures of two or more thereof, wherein more preferably the aliphatic polyisocyanates comprise hexamethylenediisocyanate-1,6, wherein more preferably the aliphatic polyisocyanates consist of hexamethylenediisocyanate-1,6.
21. The process of embodiment 19 or 20, wherein the aliphatic polyisocyanates comprise one or more cycloaliphatic compounds selected from the group consisting of 1-isocyanato-3,3,5-trimethyl-5-iso-cyanatomethyl-cyclohexane (isophorone diisocyanate, IPDI), 1,4-Bis(isocyanatomethyl)cyclohexane and/or 1,3-Bis(isocyanatomethyl)cyclohexane (HXDI), 1,4-cyclohexane diisocyanate, 1-methyl-2,4- and/or -2,6-cyclohexane diisocyanate and 4,4′-dicyclohexylmethane diisocyanate, 2,2′-dicyclohexylmethane diisocyanate, 2,4′-dicyclohexylmethane diisocyanate, cyclohexane-1,3- diisocyanate, cyclohexane-1,4-diisocyanate, 2,4-hexahydrotoluene diisocyanate, 2,6-hexahydrotoluene diisocyanate, 4,4′-dicyclohexylmethane diisocyanate, 2,2′-dicyclohexylmethane diisocyanate, 2,4′-dicyclohexylmethane diisocyanate, and mixtures of two or more thereof, preferably from the group consisting of 1-isocyanato-3,3,5-trimethyl-5-iso-cyanatomethyl-cyclohexane (isophorone diisocyanate, IPDI), 1,4-Bis(isocyanatomethyl)cyclohexane and/or 1,3-Bis(isocyanatomethyl)cyclohexane (HXDI), 1,4-cyclohexane diisocyanate, 1-methyl-2,4- and/or -2,6-cyclohexane diisocyanate and 4,4′-dicyclohexylmethane diisocyanate, 2,2′-dicyclohexylmethane diisocyanate, 2,4′-dicyclohexylmethane diisocyanate, and mixtures of two or more thereof.
22. The process of any one of embodiments 19 to 21, wherein the aromatic polyisocyanates, and preferably the aromatic diisocyanates, comprise one or more compounds selected from the group consisting of 2,4-toluene diisocyanate, 2,6-toluene diisocyanate, 4,4′-diphenylmethane diisocyanate, 2,4′-diphenylmethane diisocyanate, 2,2′-diphenylmethane diisocyanate, 1,5-naphthylene diisocyanate (NDI), 3,3′-dimethyl diphenyl diisocyanate, 1,2-diphenylethane diisocyanate, p-phenylene diisocyanate (PPDI), and mixtures of two or more thereof, preferably from the group consisting of 2,4- toluene diisocyanate (2,4-TDI), 2,6-toluene diisocyanate (2,6-TDI), 4,4′-diphenylmethane diisocyanate (4,4′-MDI), 2,4′-diphenylmethane diisocyanate (2,4′-MDI), 2,2′-diphenylmethane diisocyanate (2,2′-MDI), crude MDI obtained in the preparation of MDI, and mixtures of two or more thereof, more preferably from the group consisting of 4,4′-diphenylmethane diisocyanate, 2,4′-diphenylmethane diisocyanate, 2,2′-diphenylmethane diisocyanate, and mixtures of two or more thereof (mixtures of the isomers 4,4′-, 2,4′- and 2,2′-diphenylmethane diisocyanate are also referred to as monomeric diphenylmethane or MMDI), wherein more preferably the aromatic polyisocyanates, and preferably the aromatic diisocyanates, comprise a mixture of 4,4′-diphenylmethane diisocyanate, 2,4′-diphenylmethane diisocyanate, and 2,2′-diphenylmethane diisocyanate, wherein more preferably the aromatic polyisocyanates, and preferably the aromatic diisocyanates, consist of a mixture of 4,4′-diphenylmethane diisocyanate, 2,4′-diphenylmethane diisocyanate, and 2,2′-diphenylmethane diisocyanate.
23. The process of any one of embodiments 19 to 22, wherein the polyisocyanates comprise modified polyisocyanates, preferably modified organic polyisocyanates, and more preferably modified organic polyisocyanates containing one or more ester, urea, biuret, allophanate, carbodiimide, isocyanurate, uretdione, carbamate and/or urethane groups.
24. The process of any one of embodiments 19 to 23, wherein the oligomeric aromatic polyisocyanates comprise one or more compounds selected from the group consisting of polyphenylpolymethylene polyisocyanates, polyphenylpolyethylene polyisocyanates, and mixtures of two or more thereof, preferably from the group consisting of one or more polymethylene polyphenylisocyanates, polyethylene polyphenylisocyanates, and mixtures of two or more thereof, wherein more preferably the aromatic polyisocyanates comprise one or more polymethylene polyphenylisocyanates, wherein more preferably the aromatic polyisocyanates consist of one or more polymethylene polyphenylisocyanates.
25. The process of any one of embodiments 19 to 24, wherein the oligomeric aromatic polyisocyanates comprise one or more oligomers consisting of higher-core homologues of one or more of 4,4′-diphenylmethane diisocyanate, 2,4′-diphenylmethane diisocyanate, and 2,2′-diphenylmethane diisocyanate, wherein the higher-core homologues have at least 3 aromatic nuclei and a functionality of at least 3.
26. The process of any of embodiments 19 to 25, wherein the one or more thermosetting reactive compounds is polymeric MDI and the total amount of 4,4′-MDI in the polymeric MDI is in the range of from 26 to 98 wt.-% based on 100 wt.-% of the one or more thermosetting reactive compounds, preferably in the range of from 30 to 95 wt.-%, and more preferably in the range of from 35 to 92 wt.-%.
27. The process of any one of embodiments 19 to 26, wherein the one or more thermosetting reactive compounds is polymeric MDI and the 2 rings content of polymeric MDI is in the range of from 20 to 62%, more preferably in the range of from 26 to 48 wt.-%, and most preferably in the range of from 26 to 48% based on 100 wt.-% of the polymeric MDI
28. The process of any one of embodiments 19 to 27, wherein the one or more thermosetting reactive compounds, and preferably the total of the polyisocyanates contained therein, have an average isocyanate functionality of from 2.1 to 3.5, preferably of from 2.3 to 3.2, more preferably of from 2.4 to 3, more preferably of from 2.5 to 2.9, and more preferably of from 2.6 to 2.8.
29. The process of any one of embodiments 1 to 28, wherein the one or more thermosetting reactive compounds have an iron content in the range of from 1 to 100 wppm, preferably of from 1 to 80 wppm, more preferably of from 1 to 60 wppm, more preferably of from 1 to 40 wppm, more preferably of from 1 to 20 wppm, more preferably of from 1 to 10 wppm, and more preferably of from 1 to 5 wppm.
30. The process of any one of embodiments 1 to 29, wherein the one or more thermosetting reactive compounds display a viscosity in the range of from 100 to 3000 mPa*s, preferably of from 100 to 1000 mPa*s, more preferably of from 100 to 600 mPa*s, more preferably of from 200 to 600 mPa*s, and more preferably of from 400 to 600 mPa*s, wherein the viscosity is the viscosity measured at 25° C.
31. The process of any one of embodiments 19 to 30, wherein the epoxy resins comprise one or more compounds selected from the group of aromatic epoxy resins, cycloaliphatic epoxy resins, and mixtures of two or more thereof, preferably one or more compounds selected from the group consisting of bisphenol A bisglycidyl ether (DGEBA), bisphenol F bisglycidyl ether, ring-hydrogenated bisphenol A bisglycidyl ether, ring-hydrogenated bispheno) F bisglycidyl ether, bisphenol S bis-glycidyl ether (DGEBS), tetraglycidylmethylenedianiline (TGMDA), epoxy novolaks (the reaction products from epichlorohydrin and phenolic resins (novolak)), 3,4-epoxycyclohexylmethyl, 3,4epoxycyclohexanecarboxylate, diglycidyl hexahydrophthalate, and mixtures of two or more thereof, wherein more preferably the epoxy resins comprise bisphenol A bisglycidyl ether and/or bisphenol F bisglycidyl ether, wherein more preferably the epoxy resins consist of bisphenol A bisglycidyl ether and/or bisphenol F bisglycidyl ether.
32. The process of any one of embodiments 19 to 31, wherein the melamine formaldehyde resins comprise an aqueous melamine resin mixture with a resin content in the range of 50 to 70 wt.-% based on 100 wt.% of the aqueous melamine resin mixture, with melamine and formaldehyde present in the resin in a molar ratio of from 1:3 to 1:1, preferably of from 1:1.3 to 1:2.0, and more preferably of from 1:1.5 to 1:1.7.
33. The process of any one of embodiments 19 to 32, wherein the melamine formaldehyde resins contain 1 to 10 wt.-% of polyvalent alcohols, preferably 3 to 6 wt.-% of polyvalent alcohols, more preferably 3 to 6 wt.-% of C2 to C12 diols, more preferably 3 to 6 wt.-% of one or more compounds selected from the group consisting of diethylene glycol, propylene glycol, butylene glycol, pentane diol, hexane diol, and mixtures of two or more thereof, and more preferably 3 to 6 wt.-% of diethylene glycol.
34. The process of any one of embodiments 19 to 33, wherein the melamine formaldehyde resins contain 0 to 8 wt.-% of caprolactam and 0.5 to 10 wt.-% of 2-(2-phenoxyethoxy)ethanol and/or polyethylene glycol with an average molecular mass of 200 to 1500 each based on 100 wt.-% of the melamine formaldehyde resins.
35. The process of any one of embodiments 1 to 34, wherein in (4) the mixture is homogenized for a duration in the range of from 3 to 120 s, preferably of from 4 to 90 s, more preferably of from 6 to 60 s, more preferably of from 8 to 40 s, more preferably of from 10 to 30 s, more preferably of from 12 to 25 s, and more preferably of from 15 to 20 s.
36. The process of any one of embodiments 1 to 35, wherein in (5) the slurry is homogenized for a duration in the range of from 10 to 120 s, preferably of from 15 to 100 s, more preferably of from 20 to 80 s, more preferably of from 30 to 60 s, and more preferably of from 40 to 50 s.
37. The process of any one of embodiments 1 to 36, wherein the weight ratio of the total amount of the one or more thermosetting reactive compounds to the asphalt composition is in the range of from 0.1:99.9 to 25:75, preferably of from 0.3:99.7 to 15:85, more preferably of from 0.5:99.5 to 10:90, more preferably of from 0.8:99.2 to 7:93, more preferably of from 1:99 to 5:95, more preferably of from 1.3:98.7 to 4:96, more preferably of from 1.5:98.5 to 3.5:96.5, more preferably of from 1.8:98.2 to 3.2:96.8, more preferably of from 2:98 to 3:97, more preferably of from 2.2:97.8 to 2.8:97.2, and more preferably of from 2.4:97.6 to 2.6:97.4.
38. The process of any one of embodiments 1 to 37, wherein the weight ratio of the mixture obtained in (4) to the granular material obtained in (2) is in the range of from 0.5:99.5 to 25:75, preferably of from 1:99 to 20:80, more preferably of from 1.5:98.5 to 15:85, more preferably of from 2:98 to 10:90, more preferably of from 2.5:97.5 to 7:93, more preferably of from 3:97 to 5:95, and more preferably of from 3.5:96.5 to 4.5:95.5.
39. The process of any one of embodiments 1 to 38, wherein the granular material provided in (2) comprises one or more granular materials selected from the group consisting of gravel, reclaimed asphalt pavement, sand, one or more filler materials, and mixtures of two or more thereof, preferably from the group consisting of limestone, basanite, diabase, reclaimed asphalt pavement, and mixtures of two or more thereof, and more preferably from the group consisting of limestone, basanite, diabase, reclaimed asphalt pavement, and mixtures of two or more thereof.
40. The process of any one of embodiments 1 to 39, wherein the asphalt composition provided in (1) comprises one or more additives, preferably one or more fiber materials and/or one or more rejuvenators, wherein more preferably the asphalt composition provided in (1) comprises cellulose fibers.
41. The process of embodiment 40, wherein the asphalt composition provided in (1) comprises 10 wt.-% or less of the one or more additives based on 100 wt.-% of the asphalt composition, preferably 5 wt.-% or less, more preferably 3 wt.-% or less, more preferably 2 wt.-% or less, more preferably 1 wt.-% or less, more preferably 0.5 wt.-% or less, and more preferably 0.1 wt.-% or less of the one or more additives based on 100 wt.-% of the asphalt composition.
42. The process of any one of embodiments 1 to 41, wherein the granular material provided in (2) comprises from 5 to 100 wt.-% of reclaimed asphalt pavement, based on 100 wt.-% of the granular material, wherein more preferably the granular material comprises from 10 to 90 wt.-%, more preferably from 15 to 80 wt.-%, more preferably from 20 to 70 wt.-%, more preferably from 25 to 60 wt.-%, more preferably from 30 to 50 wt.-%, and more preferably from 35 to 45 wt.-% of reclaimed asphalt pavement, based on 100 wt.-% of the granular material.
43. The process of any one of embodiments 1 to 42, wherein the granular material provided in (2) displays a grain size in the range of from 0.1 to 70 mm, preferably of from 0.3 to 50 mm, more preferably of from 0.5 to 40 mm, more preferably of from 1 to 30 mm, more preferably of from 3 to 25 mm, more preferably of from 5 to 20 mm, more preferably of from 7 to 15 mm, and more preferably of from 8 to 11 mm.
44. The process of any one of embodiments 1 to 43, wherein addition in (4) is achieved by injection of at least a portion of the one or more thermosetting reactive compounds into at least a portion of the asphalt composition, wherein the injection is preferably achieved with the aid of a dosage pump.
45. The process of any one of embodiments 1 to 44, wherein addition in (4) is conducted in a receiver tank, preferably in a weighted receiver tank.
46. The process of embodiment 45, wherein the asphalt composition obtained in (1) is added to the receiver tank prior to the addition of the one or more thermosetting reactive compounds.
47. The process of any one of embodiments 1 to 46, wherein homogenization in (4) is achieved with the aid of one or more dynamic mixing elements, preferably with the aid of one or more circulation pumps and/or high shear mixers and/or one or more stirrers and/or one or more screws, preferably with the aid of one or more stirrers.
48. The process of any one of embodiments 1 to 47, wherein homogenization in (4) is achieved with the aid of one or more static mixing elements, preferably with the aid of one or more nozzles and/or Sulzer mixers and/or Kenics mixers.
49. The process of any one of embodiments 1 to 48, wherein homogenization in (4) is conducted at least in part in a mixing unit, preferably in a weighted stirred vessel.
50. The process of any one of embodiments 1 to 49, wherein homogenization in (4) is achieved by mixing, wherein preferably the mixing rate is in the range of from 30 to 12,000 rpm, preferably of from 50 to 8,000 rpm, more preferably of from 100 to 5,000 rpm, more preferably of from 300 to 4,000 rpm, more preferably of from 500 to 3,000 rpm, more preferably of from 800 to 2,500 rpm, more preferably of from 1,000 to 2,000 rpm, more preferably of from 1,200 to 1,800 rpm, and more preferably of from 1,400 to 1,600 rpm.
51. The process of any one of embodiments 1 to 50, wherein addition in (5) is achieved by injection of at least a portion of the mixture obtained in (4) into at least a portion of granular material obtained in (2), wherein the injection is preferably achieved with the aid of a dosage pump.
52. The process of any one of embodiments 1 to 51, wherein homogenization in (5) is achieved by with the aid of one or more dynamic mixing elements, preferably with the aid of one or more stirrers and/or one or more screws, more preferably with the aid of a double shaft compulsory mixer (twin-shaft pugmill).
53. The process of any one of embodiments 1 to 52, wherein homogenization in (5) is conducted in a mixing device, wherein preferably the mixing device is part of an asphalt mixing plant.
54. The process of embodiment 53, wherein the granular material obtained in (2) is added to the mixing device prior to the addition of the mixture obtained in (4).
55. The process of any one of embodiments 1 to 54, wherein in (4), addition and homogenization are conducted simultaneously.
56. The process of any one of embodiments 1 to 55, wherein in (5), addition and homogenization are conducted simultaneously.
57. The process of any one of embodiments 1 to 56, wherein (4) and/or (5), preferably (4) and (5), are conducted under an oxygen containing atmosphere, preferably under an atmosphere containing oxygen in an amount from 1 to 21 vol.-%, more preferably from 5 to 21 vol.-%, and more preferably from 10 to 21 vol.-%, wherein more preferably (4) and/or (5), preferably (4) and (5), are conducted under air.
58. The process of any one of embodiments 1 to 57, wherein (4) and/or (5), preferably (4) and (5), are conducted as a batch process or as a continuous process, preferably as a continuous process.
59. An asphalt mix composition obtained according to the process of any one of embodiments 1 to 58.
60. Use of an asphalt mix composition according to embodiment 59 for pavement applications.

The present invention is further illustrated by the following examples and reference examples.

### EXPERIMENTAL SECTION

### Characterization Methods—Asphalt Tests

Softening Point DIN EN 1427

Two horizontal disks of bitumen, cast in shouldered brass rings, are heated at a controlled rate in a liquid bath while each supports a steel ball. The softening point is reported as the mean of the temperatures at which the two disks soften enough to allow each ball, enveloped in bitumen, to fall a distance of 25±0.4 mm.

Rolling Thin Film Oven Test (RTFOT) DIN EN 12607-1

Bitumen is heated in bottles in an oven for 75 min at 163° C. The bottles are rotated at 15 rpm and heated air is blown into each bottle at its lowest point of travel at 4000 mL/min. The effects of heat and air are determined from changes in physical test values as measured before and after the oven treatment.

Pressure Aging Vessel (PAV) DIN EN 14769

The residue from the RTFOT is placed in standard stainless steel pans and aged at a specified conditioning temperature (90° C., 100° C. or 110° C.) for 20 h in a vessel pressurized with air to 2.10 MPa. The temperature is selected according to the grade of the asphalt binder (application). Finally, the residue is vacuum degassed.

Dynamic Shear Rheometer (DSR) DIN EN 14770-ASTM D7175

A dynamic shear rheometer test system consists of parallel plates, a means for controlling the temperature of the test specimen, a loading device, and a control and data acquisition system.

Temperature Sweep DIN EN 14770

This test has the objective of measuring the complex shear modulus and phase angle of asphalt binders. The test consists in pressing an 8 or 25 mm diameter test specimen between parallel metal plates at a defined frequency and temperature. One of the parallel plates is oscillated with respect to the other at, in this case, 1.59 Hz and angular deflection amplitudes. The required amplitudes must be selected so that the testing is within the region of linear behavior. This is repeated at 30, 40, 50, 60, 70, 80 and 90° C.

Multiple Stress Creep Recovery Test (MSCRT) DIN EN 16659-ASTM D7405

This test method is used to determine the presence of elastic response in an asphalt binder under shear creep and recover at two stress level (0.1 and 3.2 kPa) and at a specified temperature (60° C.). This test uses the DSR to load a 25 mm at a constant stress for 1 s, and then allowed to recover for 9 s. Ten creep and recovery cycles are run at 0.100 kPa creep stress followed by ten cycles at 3.200 kPa creep stress.

Bending Beam Rheometer (BBR) DIN EN 14771-ASTM D6648

This test is used to measure the mid-point deflection of a simply supported prismatic beam of asphalt binder subjected to a constant load applied to its mid-point. A prismatic test specimen is placed in a controlled temperature fluid bath and loaded with a constant test load for 240 s. The test load (980±50 mN) and the mid-point deflection of the test specimen are monitored versus time using a computerized data acquisition system. The maximum bending stress at the midpoint of the test specimen is calculated from the dimensions of the test specimen, the distance between supports, and the load applied to the test specimen for loading times of 8.0, 15.0, 30.0, 60.0, 120.0 and 240.0 s. The stiffness of the test specimen for the specific loading times is calculated by dividing the maximum bending stress by the maximum bending strain.

### Characterization Methods—Asphalt Mix Composition Tests

Cyclic Compression Test (CCT)-TP Asphalt-StB Teil 25 B1 DIN EN 12697-25:2016

The Uniaxial Cyclic compression test is used to determine the deformation behavior of asphalt specimens. In this test, the specimen is tempered for 150±10 min at 50±0.3° C., which is the same temperature at which the test is conducted. After the tempering period, the specimen is set on the universal testing machine and loaded cyclically. Each cycle lasts 1.7 s, where the loading time is 0.2 s and the pause lasts 1.5 s. The upper load applied is 0.35 MPa and the lower one is 0.025 MPa. The number of cycles and the deformation are registered. The test ends either when 10,000 load cycles are completed or when the deformation is higher than 40%.

Indirect Tensile Strength Test-TP Asphalt-StB Teil 23 DIN EN 12697-23:2003

The indirect tensile strength test is used to determine the fatigue behavior of asphalt specimens. The asphalt mixtures is conducted by loading a cylindrical specimen across its vertical diametral plane at a specified rate (in this case 50±0.2 mm/min) of deformation and test temperature (in this case 20±2° C.). The peak load at failure is recorded and used to calculate the indirect tensile strength of the specimen.

Uniaxial Tensile Stress Test and Thermal Stress Restrained Specimen Test-TP Asphalt-StB Teil 46A (LTT =Low Temperature Tests) DIN EN 12697-46:2012

The uniaxial tensile stress test and thermal stress restrained specimen test is used to determine the cold behavior of asphalt specimens. Low-temperature cracking of asphalt mixtures results from thermal shrinkage during cooling, inducing tensile stress in the asphalt mixture. In order to simulate the situation in pavement layers the following test methods on asphalt specimens according to the European Standard EN 12697-46:2012 are used:

(i) Thermal Stress Restrained Specimen Test (TSRST): while the deformation of the specimen is restrained, the temperature is reduced by a prespecified cooling rate;

(ii) Uniaxial Tensile Strength Test (UTST): in order to assess the risk of low-temperature cracking, the stress induced by thermal shrinkage is compared with the respective tensile strength.

Wheel Tracking Test-TP Asphalt-StB Teil 22 DIN EN 12697-22:2003

The wheel tracking test used to determine deformation (rut) depth of an asphalt mixture subjected to cycles of passes of a loaded rubber wheel under constant and controlled temperature conditions. Normally 10,000 cycles done at 50° C.

### EXAMPLE 1

### Preparation of an Asphalt Mix Composition in an Asphalt Mixing Plant—Short Mixing Duration of Asphalt and Thermosetting Reactive Compound

1920 kg of coarse gravel having a grain size of from 8 to 11 mm is heated to a temperature of 180° C. and placed in a mixing unit. 80 kg of asphalt displaying a needle penetration of 7-10 mm according to DIN EN 1426 (=needle penetration of 70-100) which has been preheated to a temperature of 160-170° C. is weighed into a stirring vessel, and 2.075 kg of polymeric diphenylmethane diisocyanate having an average isocyanate functionality of 2.7 (designated in the following as “As20”) is then added to the asphalt under stirring (1,500 rpm) and the resulting mixture is then further stirred, wherein the dosage speed is set between 0.1 L/s and 2.0 L/s and the stirring time is set to 20 s. The resulting modified asphalt is then added to the coarse gravel in the mixing unit under stirring, and the mixture is then further stirred, wherein the total duration of further stirring is 30s. The resulting asphalt mix composition had a temperature of 171.6° C. Subsequently, the modified asphalt was separated off from the coarse gravel (by letting it drip off) and further analyzed. The softening point was determined to be 52.4° C.

### EXAMPLE 2

### Preparation of an Asphalt Mix Composition in an Asphalt Mixing Plant—Short Mixing Duration of Asphalt and Thermosetting Reactive Compound

Examples 1 was repeated, wherein the resulting asphalt mix composition had a temperature of 173.4° C. Subsequently, the modified asphalt was separated off from the coarse gravel (by letting it drip off) and further analyzed. The softening point was determined to be 52.4° C.

### COMPARATIVE EXAMPLE 1

### Preparation of an Asphalt Mix Composition in an Asphalt Mixing Plant—Long Mixing Duration of Asphalt and Thermosetting Reactive Compound

Example 1 was repeated, however the step of the addition of As20 to the asphalt was modified such that the resulting mixture was further stirred for a longer period of time, such that the total duration of the further stirring is 300 s. The resulting asphalt mix composition had a temperature of 175.4° C. Subsequently, the modified asphalt was separated off from the coarse gravel (by letting it drip off) and further analyzed. The softening point was determined to be 53.9° C.

### COMPARATIVE EXAMPLE 2

### Preparation of an Asphalt Mix Composition in an Asphalt Mixing Plant—Long Mixing Duration of Asphalt and Thermosetting Reactive compound

Example 1 was repeated, however the step of the addition of the As20 to the asphalt was modified such that the resulting mixture was again further stirred for a longer period of time, such that the total duration of the further stirring is 600 s. The resulting asphalt mix composition had a temperature of 172.8° C. Subsequently, the modified asphalt was separated off from the coarse gravel (by letting it drip off) and further analyzed. The softening point was determined to be 53.8° C.

### EXAMPLE 3

### Preparation of an Asphalt Mix Composition in an Asphalt Mixing Plant—Short Mixing Duration of Asphalt and Thermosetting Reactive Compound Combined with Long Mixing Duration of Granular Material with the Mixture of Asphalt and Thermosetting Reactive Compound

Example 1 was repeated, however the step of the addition of the modified asphalt to the coarse gravel was modified such that the resulting mixture was further stirred for a longer period of time, such that the total duration of the further stirring is 60 s. The resulting asphalt mix composition had a temperature of 172.8° C. Subsequently, the modified asphalt was separated off from the coarse gravel (by letting it drip off) and further analyzed. The softening point was determined to be 56.7° C.

TABLE 1
Results of Examples 1-3 and Comparative Examples 1 and 2

| | Total duration of | Total duration of | |
|---|---|---|---|
| | addition + mixing | addition + mixing | Softening |
| | of asphalt with | modified with | point* |
| Experiment | As20 [s] | coarse gravel [s] | [° C.] |
| Example 1 | 20 | 30 | 52.4 |
| Example 2 | 20 | 30 | 52.4 |
| Comp. Example 1 | 300 | 30 | 53.9 |
| Comp. Example 2 | 600 | 30 | 53.8 |
| Example 3 | 20 | 60 | 56.7 |

*softening point of unmodified (paving grade) asphalt: 46.6° C.

### EXAMPLE 4

### Preparation of an Asphalt Mix Composition Without Mixing of Asphalt and As20 Additive

Various asphalt mix compositions are prepared in an asphalt mixing plant. For all mixtures, the amount of granular material and asphalt is as follow (the granulometric curve chosen is a SMA 11 S): 519 kg sand (grain size 0 to 2 mm), 282 kg gravel split (2-5 mm), 372 kg gravel split (5-8 mm), 1.092 kg gravel split (8-11 mm), 300 kg gravel split (11-16 mm), 60 kg filler, 180 kg limestone, 9 kg cellulose fiber, and 186 kg asphalt displaying a needle penetration of 5-7 mm according to DIN EN 1426 (=needle penetration of 50-70) which has been preheated to a temperature of 170-180° C. The granular material has been preheated to a temperature of 182° C.

TABLE 2
Analysis of prepared asphalt mix compositions.

| | | | Sieving analysis - mass percentage of different grain | | | | | | | | |
|---|---|---|---|---|---|---|---|---|---|---|---|
| | | Asphalt | sizes [wt. %] | | | | | | | Softening | Asphalt mix |
| | | content | ≤0.063 | ≤0.125 | ≤2 | ≤5.6 | ≤8 | ≤11.2 | ≤16.0 | point | temperature |
| | Dosage type | [wt.] | mm | mm | mm | mm | mm | mm | mm | [° C.] | [° C.] |
| 1 | No As20 | 6.1 | 9.8 | 11.5 | 25.1 | 38.0 | 56.5 | 98.1 | 100.0 | 53.8 | 175° C. |
| | (comparative) | | | | | | | | | | |
| 2 | Asphalt + 2.5 | 6.3 | 10.1 | 11.2 | 25.2 | 38.0 | 58.7 | 97.7 | 100.0 | 53.1 | 174° C. |
| | wt. % As20, | | | | | | | | | | |
| | simultaneous | | | | | | | | | | |
| 3 | 2.5 wt. % As20, | 6.2 | 9.1 | 10.7 | 23.7 | 36.8 | 55.0 | 97.4 | 100.0 | 53.6 | 172° C. |
| | then asphalt | | | | | | | | | | |

As comparative example, no As20 is added to the asphalt. In case of As20 addition, 4.65 kg of As20 (2.5 wt.% referred to the employed amount of asphalt) are added to the asphalt in two different ways: a) simultaneous addition of As20 and asphalt into the balance and b) addition of

As20 first followed by the addition of the asphalt. Independent of the type of addition, stirring the asphalt-As20-mixture is not carried out. The resulting mixture / asphalt without As20 additive is then added to the granular material in the mixing unit under stirring, and the mixture is then further stirred, wherein the total duration of the further stirring is 30 s. For each variant (see Table 2: (1) no As20 additive, (2) simultaneous addition of As20 and asphalt into the balance, (3) addition of As20 first followed by the asphalt), two batches according to the abovementioned composition were prepared. The resulting asphalt mix compositions had temperatures between 172° C. and 175° C. (see Table 2). Subsequently, the three different asphalt mix compositions were further analyzed. According results are shown in Table 2.

Thus, it has surprisingly been found that the duration of the mixing of the thermosetting reactive compound with the asphalt prior to its addition to the granular material has substantially no influence on the softening point (i.e. degree of modification) of the resulting asphalt mix composition. However, as example 4 demonstrates, mixing is necessary to provide a modification of the asphalt. It has quite unexpectedly been found that the duration of mixing of the resulting mixture of the modified asphalt with the coarse gravel substantially increases the softening point of the resulting asphalt mix. As a result, it has quite surprisingly been found that a very brief mixing process of the components of an asphalt mix composition containing an asphalt which has been modified with a thermosetting reactive compound leads to a product with excellent properties. Therefore, the present invention provides a highly efficient process for the preparation of an asphalt mix composition which not only affords considerable savings in time and energy, but furthermore allows for the in-line blending of the components immediately before employing the product for pavement applications.

### REFERENCE EXAMPLE 5

### Comparison Between Unmodified, Batch and Inline Modified Asphalt Samples Prepared Under Laboratory Conditions

General Procedure for the Preparation of a Batch Modified Asphalt Composition According to the Art (Comparative)

2.5 kg of asphalt of the respective grade according to table 3 was heated up to 140° C. under air and under stirring at 400 rpm in an oil bath (temperature is set to 150° C.). When the internal temperature of 100° C. was reached, 50 g of the respective thermosetting reactive compound (2 wt. % As20 referred to the employed amount of asphalt) according to table 3 was added to the melted asphalt. The reaction is further carried out at 140° C. for 420 minutes before being cooled down at room temperature. The samples were dispatched into cans for further testing and stored at room temperature.

General Procedure for the Preparation of an Inline Modified Asphalt Composition (Inventive)

350 g of asphalt of the respective grade according to table 3 was heated up to 150° C. under air in an oven (temperature set to 150° C.). 7 g of the respective thermosetting reactive compound (2 wt. % As20 referred to the employed amount of asphalt) according to table 3 was added to the melted asphalt. The mixture is stirred for a few seconds (<10 s) to achieve homogeneity. Than the samples are split into 35 g+/−0.5 g portions to carry out the rolling thin film oven test for the short-term aging (RTFOT, see section “characterization methods”), which simulates the aging of asphalt starting from the mixing process, followed by the transportation of the asphalt mix composition to the construction site until the laydown of the asphalt mixture. After aging, the modified asphalt is stored at room temperature or employed for further tests such as for example long-term aging tests (PAV, see section “characterization methods”).

Following the procedure as described for comparative example 5 and inventive example 5, it was surprisingly found that the inline modification of asphalt delivers essentially the same asphalt performance values as the batch modification method described in WO 2018/228840 A1. In detail, MSCR and DSR values demonstrate an increase of elasticity and stiffness at the high temperature conditions. At the same time, the same low temperature performance is achieved as can be seen from the BBR values. The useful temperature interval (UTI) is increased from 80.1° C. (unmodified (paving grade) asphalt) to 87.7° C. (As20 modified asphalt, inventive example) which within errors is essentially the same increase as achieved with the batch modification method (87.9° C.).

TABLE 3
Results of comparative and inventive example 5.

| | | Bitumen type | | |
|---|---|---|---|---|
| | | Pen 50/70 | | |
| | | Modification | | |
| | | | Comparative | Inventive |
| | | Unmodified | Example + | Example + |
| | | (paving | 2.0 wt. % | 2.0 wt. % |
| | | grade) | As 20 | As20 |
| Preparation Method | | | Batch | Inline |
| MSCRT after | Rn 3.2 kPa | 2.0 | 23.36 | 19.3 |
| RTFOT | Jnr 3.2 kPa | 1.66 | 0.32 | 0.34 |
| DSR after | G* at 60° C. | 7816 | 19054 | 19012 |
| RTFOT | δ at 60° C. | 83.2 | 73.0 | 74.3 |
| | G* = 2200 | 69.7 | 78.2 | 77.7 |
| BBR after | m-value | −10.4 | −9.7 | −10.0 |
| PAV | Stiffness | −14.0 | −13.7 | −14.1 |
| Useful | ° C. | 80.1 | 87.9 | 87.7 |
| temperature | | | | |
| interval (UTI) | | | | |

Concluding, as may be taken from the comparison of the results for the comparative and the inventive example in Table 3, the inventive example and the comparative example display about the same values for the tests which were conducted. Thus, it has again quite surprisingly been found that even after an extremely short mixing step after addition of the thermosetting reactive compound of only a few seconds, the resulting asphalt displays a quality which is comparable to that of asphalt which was subject to 7 h of mixing. This is highly unexpected considering the enormous difference in the duration of the mixing stage between the inventive and the comparative example.

### EXAMPLE 6

### Comparison Between Unmodified, Batch and Inline Modified Asphalt Mix composition Samples Prepared Under Laboratory Conditions

Preparation of the Asphalt Mixture Composition

The granulometric curve chosen was a SMA 8 S.

TABLE 4
Mass percentage in view of different aggregate size in [mm].

| | Aggregate Size [mm] | | | | | | |
|---|---|---|---|---|---|---|---|
| | ≤0.063 | 0.063 | 0.125 | 2 | 5.6 | 8 | 11.2 |
| [wt. %] | 11.3 | 2.7 | 13.7 | 19.1 | 48.2 | 5.0 | 0.0 |
| Pass [wt. %] | — | 11.3 | 14.0 | 27.7 | 46.8 | 95.0 | 100.0 |

The composition of the granular material employed for the asphalt mix composition is as follows:

| | Weight ratio | | |
|---|---|---|---|
| | [wt. %] | Type | Delivered Grade |
| 1 | 11.0 | Limestone | Filler - 0/0.063 |
| 2 | 16.0 | Basanite | Fine Aggregate - 0/2 |
| 3 | 16.0 | Diabase | Coarse Aggregate - 2/5 |
| 4 | 57.0 | Diabase | Coarse Aggregate - 5/8 |

The asphalt mix composition consisting of granular material, asphalt and fibers is as follows:

| | Weight ratio | |
|---|---|---|
| | [wt. %] | Type |
| 1 | 92.85 | Granular material (see composition above) |
| 2 | 6.87 | Asphalt pen 50/70 (unmodified, batch |
| | | modified, inline modified) |
| 3 | 0.28 | Fiber (Innocell Fiber3000) |

For the preparation of asphalt mix compositions, the TP Asphalt-StB Part 35 norm was used. The following procedure was followed:

Mixing the Components

At a temperature of 150±5° C. the stone mastic asphalt is mixed in the following order:
1. Coarse aggregate
2. Filler and fine aggregate
3. Fibers
4. Dry mixing for 2 min
5. Stir the respective unmodified (paving grade) asphalt or modified asphalt separately and then add to the mixture obtained after carrying out step 1-4; for the inline variant, the additive (2.0 wt. % As20 referred to the employed amount of asphalt) is added to the unmodified (paving grade) asphalt and stirred shortly (<60 s) to achieve homogeneity; the batch modified variant is prepared as described under example 5 (2.0 wt. % As20 referred to the employed amount of asphalt);
6. Mixing for 5 min at 30 rpm in an asphalt laboratory mixer (not hermetically sealed, exposed to air).

Storage

After mixing, the mixture is stored under air (storage container is not closed) for 1-3 h at 10° C. above the compaction temperature.

Production and Compaction of the Test Specimens

For the production and compaction of the specimens, the TP Asphalt-StB Part 33 norm was used. This norm explains the procedure to produce test specimen in the laboratory with the rolling compaction machine (Walzsektor-Verdichtungsgerat).

To prepare the test specimen, the hot mixed asphalt mixture was poured in plates and compacted with the help of the rolling compaction machine. The plates are 320 mm long, 260 mm wide and at least 40 mm high. The height of the plates depends on the specimen dimensions required for a specific test.

To compact the plates, the equipment (machine, mold and press) must be tempered at 80° C., while the mixture temperatures during the compaction comply with the following (table 5).

TABLE 5
Overview of compacting temperature
and storage temperature of mixture.

| | Storage temperature |
|---|---|
| Compaction temperature during the production | of the Mixture |
| 135 ± 5° C. for paving grade asphalt | 145 ± 5° C. for max. 3 h |
| (according to the TL Bitumen-StB) | |
| 145 ± 5° C. for PmB | 155 ± 5° C. for max. 3 h |
| (according to the TL Bitumen-StB) | |

Sawing of the Test Specimens

After the production of the plates, these must be sawed in the required dimensions. The dimensions depend on the test.

TABLE 6
Results of comparative testing in Example 6

| | | Bitumen type | | |
|---|---|---|---|---|
| | | Pen 50/70 | | |
| | | Modification | | |
| | | Unmodified | Comparative | Inventive |
| | | (paving | Ex. + 2.0% | Example + |
| | | grade) | As20 | 2.0% As20 |
| Preparation Method | | | Batch | Inline |
| Deformation | Inflection point | 2117 | 9178 | 9344 |
| behavior | Deformation | 13.5 | 0.8 | 0.265 |
| | rate at | | | |
| | Inflection point | | | |
| Cold | Max. tensile | 4.088 | 3.997 | 3.886 |
| behavior | strength | | | |
| | Break | −25.7 | −23.6 | −24.0 |
| | temperature | | | |

As may be taken from the comparison of the results for the comparative and the inventive example in Table 6, the inventive example displays about the same cold behavior values compared to the comparative example. With regard to the deformation behavior of the samples, however, the inventive sample displays a better result relative to the inflection and in particular a lower deformation rate at the inflection point. Thus, it has quite unexpectedly been found that next to displaying comparable qualities when compared to a material according to the art even though the mixing step of the asphalt/thermosetting reactive compound mixture according to the inventive process is so short, the inventive materials even display qualities which are better than those obtained according to the art, although one would expect a considerably longer mixing stage to afford improved results, if not to be indispensable for even providing any results which are substantially improved compared to the use of unmodified (paving grade) asphalt. Again, it is emphasized that this is highly unexpected considering the enormous difference in the duration of the mixing stage between the inventive and the comparative example.

### EXAMPLE 7

### Control of Laboratory results Under Real Conditions in an Asphalt Mixing Plant Equipped with a Customized Dosing System for the Thermosetting Reactive Compound

Preparation of the Asphalt Mix Composition (the Granulometric Curve Chosen was a AC 22 BS)

An asphalt mixing plant was equipped with a customized dosing system (heatable dosing line, dosing pump) which allows the dosage of the thermosetting reactive compound to the asphalt balance (stirred vessel) of the asphalt mixing plant. Furthermore, the asphalt balance was equipped with a stirrer which is engaged when i) a thermosetting reactive compound is dosed and ii) a minimum filling level of 20 kg asphalt is reached. The amount and speed of additive dosage as well as mixing is controlled via the process control system of the asphalt mixing plant.
The control of laboratory results focuses on the property changes between unmodified (paving grade) asphalt pen 70/100 (a needle penetration of 7-10 mm according to DIN EN 1426) and asphalt pen 70/100 (a needle penetration of 7-10 mm according to DIN EN 1426) modified with 1.25 wt. % of the thermosetting reactive compound As20. For each variant (unmodified and inline modified) a batch size of 4 tons asphalt mix composition was chosen. The grain size distribution given in Table 7 is adjusted by 50 wt. % virgin granular material (filler (grain size: 0-0.063 mm), fine aggregates (grain size: 0-2 mm) and coarse aggregates (grain size: 2-5 mm, 5-8 mm, 8-11 mm, 11-16 mm, 16-22 mm) were employed) and 50 wt. % reclaimed asphalt pavement material. The total asphalt content in the mixture of asphalt and granular material was 4.3 wt. %, i.e. 172 kg asphalt per 4 t batch. 100 kg of 172 kg asphalt originate from the reclaimed asphalt pavement material and the remaining 72 kg stem from the addition of unmodified (paving grade) asphalt pen 70/100. In case of the inventive example, the employed amount of thermosetting reactive compound As20 was 2.16 kg, i.e. 1.25 wt. % referred to the total amount of employed asphalt (i.e. asphalt from reclaimed asphalt pavement material+unmodified (paving grade) asphalt pen 70/100). Virgin granular material and reclaimed asphalt pavement material were preheated separately from each other and subsequently mixed together for 6 s so that the temperature of the according mixture does not exceed 200° C. 72 kg unmodified (paving grade) asphalt pen 70/100 was preheated to a temperature of 175-180° C. and weight into the stirring vessel (=asphalt balance), and in case of the comparative example 2.16 kg of As20 is then added to the asphalt under stirring (1500 rpm) and the resulting mixture is then further stirred, wherein the dosage speed is set between 0.1 L/s and 2.0 L/s and the stirring time is set to 20 s. The resulting modified asphalt together with the granular material (mixture of virgin granular material and reclaimed asphalt pavement material having a temperature of 200° C.) were added to the mixing unit (double shaft compulsory mixer) and the resulting mixture is further stirred, wherein the total duration of further stirring is 30 s. The temperature of the asphalt mix composition at this stage of the process was determined to be 175-180° C. Subsequently, the asphalt mix composition was released to the silo where it may be loaded onto a truck or stored for several hours. All obtained asphalt mix compositions were further analyzed. The results are given in Table 8.

TABLE 7
Composition of the granular material of the prepared
asphalt mix compositions (aggregate sizes by weight).

| | Aggregate Size [mm] | | | | | | |
|---|---|---|---|---|---|---|---|
| | Filler | 0/2 | 2/5 | 5/8 | 8/11 | 11/16 | 16/22 |
| [wt. %] | 7.0 | 19.1 | 16.6 | 8.8 | 7.9 | 9.9 | 30.7 |

TABLE 8
Results of comparative testing in Example 7

| | | Comparative | |
|---|---|---|---|
| | | Example | |
| | | Unmodified | Example + |
| | | (paving grade) | 1.25% |
| | | asphalt | As20 |
| Bitumen | Softening point [° C.] | 58.0 | 60.6 |
| | Recovery at 3.2 kPa [%] | 5.9 | 12.0 |
| | Jnr at 3.2 kPa [1/kPa] | 0.903 | 0.644 |
| Marshall | Bitumen content [%] | 4.4 | 4.5 |
| samples | Air void content [%] | 3.6 | 3.4 |

When comparing the results for the comparative and the inventive example in Table 8, it is apparent that the results obtained in the foregoing examples under laboratory conditions are also obtained under real conditions. Accordingly, the results in table 8 confirm the surprising technical effects obtained under laboratory conditions for the inline testing experiments of the preceding examples despite the fact that an extremely short mixing stage was employed compared to the mixing procedures of the asphalt with the thermosetting reactive compound as taught in the prior art.

### CITED LITERATURE

WO 01/30911 A1
WO 01/30912 A1
WO 01/30913 A1
https://eapa.org/wp-content/uploads/2018/07/EAPA-paper-Warm-MixAsphalt-version-2014-1.pdf: “The use of Warm Mix Asphalt”, EAPA Position Paper, 1 Jan. 2014, pp 1-23
https://www.faa.gov/documentlibrary/media/advisory_circular/150-5370-14A/150_5370_14a_app1_part_II_a.pdf Anonymous: “Hot Mix Asphalt Paving Handbook, AC 150/5370-14A, Appendix 1, Part II-a”, 1 Jan. 2001, pp 1-11
http://web.archive.org/web/20071223141536/http://www.in.gov/indot/files/chapter_03(5).pdf Anonymous: “HOT MIX ASPHALT PLANT OPERATIONS, Chapter 3”, 23 Dec. 2007, pp 1-78
http://www.astecinc.com/images/file/literature/Nomad_with_Baghouse.pdf Anonymous: “NOMAD™ Hot Mix Asphalt Plant”, 1 Jan. 2008, pp 1-5
https://store.asphaltpavement.org/pdfs/ec-101.pdf Anonymous: “Best Management Practices To Minimize Emissions During HMA Construction; EC-101 4/00”, 1 Apr. 2000, pp 1-12
Malcolm D Graham et al.: “Reduced Mixing Time for Asphalt Concrete Mixes”, Paper presented at the 47th Annual Meeting, 1 Jan. 1968 , pp 1-17
BECKER Y et al.: “Polymer Modified Asphalt”, VISION TECNOLOGICA, INTEVEP, LOS TEQUES, VE, vol. 9, no. 1, 1 January 2001, pp 39-50
Bjarne Bo Jensen et al.: “15 YEARS EXPERIENCE ADDING POLYMER POWDER DIRECTLY INTO THE ASPHALT MIXER”, 5th Eurasphalt & Eurobitume Congress, 13-15 Jun. 2012, Istanbul, 15 Jun. 2012, pp 1-8
HESAMI EBRAHIM et al.: “Study of the amine-based liquid anti-stripping agents by simulating hot mix asphalt plant production process”, CONSTRUCTION AND BUILDING MATERIALS, vol. 157, 2017, pp 1011-1017
LUO SANG et al.: “Performance evaluation of epoxy modified open graded porous asphalt concrete”, CONSTRUCTION AND BUILDING MATERIALS, ELSEVIER, NETHERLANDS, vol. 76, 12 Dec. 2014, pp 97-102
FANG CHANGQING et al.: “Preparation and properties of isocyanate and nano particles composite modified asphalt”, CONSTRUCTION AND BUILDING MATERIALS, ELSEVIER, NETHERLANDS, vol. 119, 13 May 2016, pp 113-118
EP 3 006 525 A1
WO 2017/125421 A1
EP 0 537 638 B1
WO 2018/228840 A1

1.-15. (canceled)

16. A process for the preparation of an asphalt mix composition, said process comprising:
(1) providing an asphalt composition and heating said composition to a temperature in the range of from 110 to 200° C.;
(2) providing a granular material and heating said material to a temperature in the range of from 110 to 240° C.;
(3) providing one or more thermosetting reactive compounds;
(4) adding the one or more thermosetting reactive compounds provided in (3) to the asphalt composition obtained in (1) and homogenizing the mixture for a duration in the range of from 2 to 180 s;
(5) adding the mixture obtained in (4) to the granular material obtained in (2) and homogenizing the slurry for a duration in the range of from 5 to 180 s.

17. The process of claim 16, wherein after (4) and prior to (5) the mixture obtained in (4) is stored at a temperature in the range of from 60 to 190° C.

18. The process of claim 16, wherein after (4) and prior to (5) the mixture obtained in (4) is subject to mixing at a mixing rate of 100 rpm or less.

19. The process of claim 16, wherein the mixture obtained in (4) is directly processed in (5).

20. The process of claim 16, wherein the one or more thermosetting reactive compounds comprise one or more compounds selected from the group consisting of polyisocyanates, epoxy resins, melamine formaldehyde resins, and mixtures of two or more thereof.

21. The process of claim 16, wherein the weight ratio of the total amount of the one or more thermosetting reactive compounds to the asphalt composition is in the range of from 0.1:99.9 to 25:75.

22. The process of claim 16, wherein the weight ratio of the mixture obtained in (4) to the granular material obtained in (2) is in the range of from 0.5:99.5 to 25:75.

23. The process of claim 16, wherein the granular material provided in (2) comprises one or more granular materials selected from the group consisting of gravel, reclaimed asphalt pavement, sand, one or more filler materials, and mixtures of two or more thereof.

24. The process of claim 16, wherein the asphalt composition provided in (1) comprises one or more additives.

25. The process of claim 16, wherein the granular material provided in (2) comprises from 5 to 100 weight-% of reclaimed asphalt pavement.

26. The process of claim 16, wherein the granular material provided in (2) displays a grain size in the range of from 0.1 to 70 mm.

27. The process of claim 16, wherein (4) and/or (5) are conducted under an oxygen containing atmosphere.

28. The process of claim 16, wherein (4) and/or (5) are conducted as a batch process or as a continuous process.

29. An asphalt mix composition obtained or obtainable according to the process of claim 16.

30. Use of an asphalt mix composition according to claim 29 for pavement applications.
